(19) United States
(12) Patent Application Publication
(10) Pub. No.: US 2008/0296457 A1
(43) Pub. Date: Dec. 4, 2008

(54) FURNITURE STORAGE UNIT AND METHOD

(75) Inventors: Allen C. Hager, Grand Rapids, MI (US); Robert E. Jeffers, Ada, MI (US); William K. Hofman, Ada, MI (US); Brian L. Bultsma, Byron Center, MI (US); Scott Michael Miller, Middleville, MI (US); Marvin C. Knauf, Conklin, MI (US); Karl Heinz Mueller, Rosenheim (DE); John R. Hamilton, Grand Rapids, MI (US); Karl J. Mead, East Grand Rapids, MI (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: Steelcase Inc.

(21) Appl. No.: 12/129,097

(22) Filed: May 29, 2008

Related U.S. Application Data
(60) Provisional application No. 60/940,913, filed on May 30, 2007.
(60) Provisional application No. 60/940,879, filed on May 30, 2007.
(60) Provisional application No. 60/940,899, filed on May 30, 2007.
(60) Provisional application No. 60/940,891, filed on May 30, 2007.

(51) Int. Cl. A47F 5/08; F16B 45/00

(52) U.S. Cl. 248/305; 312/245; 312/246

(57) ABSTRACT

An office furniture unit has an outer face with slotted hangers, and a removable storage unit assembly including a bottom panel positioned in a generally horizontal orientation along the office furniture unit, and a top panel disposed above and generally parallel with the bottom panel. First and second panels are disposed at opposite ends of the top and bottom panels and are connected therewith to define a rigid, box-shaped case having an open back portion. The first and second end panels have rear portions with multiple vertically spaced slots. First and second hanger brackets have a rear portion with first hooks selectively received in the slotted hangers of the office furniture units, and a forward portion with second hooks selectively received in the slots in the rear portions of the first and second end panels to detachably support the case against the outer face of the office furniture unit.

### CROSS REFERENCE TO RELATED APPLICATIONS

The present application claims benefit under 35 U.S. C. §119(e) of provisional application Ser. No. 60/940,913, filed May 30, 2007, entitled FURNITURE STORAGE UNIT AND METHOD; provisional application Ser. No. 60/940,879, entitled STORAGE UNIT ATTACHMENT SYSTEM AND METHODS, filed May 30, 2007; provisional application Ser. No. 60/940,899, entitled STORAGE UNIT DOOR APPARATUS AND METHOD, filed May 30, 2007; and provisional application Ser. No. 60/940,891, entitled STORAGE UNIT BACK STOP AND METHOD, and is related to co-pending application entitled STORAGE UNIT BACK STOP AND METHOD, filed on even date herewith. The entire contents of each of the aforementioned applications are incorporated herein by reference.

### BACKGROUND OF THE INVENTION

The present invention relates to storage units for office furniture and the like, and in particular to an adaptable modular construction therefor.

Modular office systems are oftentimes used to convert large open floor spaces in buildings into individual workstations and other useable office settings. Due to constantly changing work environments, office systems that are versatile and allow for easy and convenient rearrangement are quite beneficial. Some panel systems require specifically configured storage components and case assemblies, and therefore lack the ability to interface with other types of furniture systems.

In an effort to increase the versatility of storage units, components that may be used across a wide variety of furniture systems and in multiple storage unit assemblies would be useful. In the past, such arrangements have proven difficult to design and costly to produce. Accordingly, a storage unit construction and associated components that can be used in multiple office environments with fewer parts and provide easy installation is desired and would be considered advantageous.

### SUMMARY OF THE INVENTION

One aspect of the present invention is a storage unit assembly for office furniture units of the type having an outer face with slotted hangers extending therealong, and includes a bottom panel operably positioned in a generally horizontal orientation, and shaped to abuttingly support objects thereon. A top panel is disposed above and generally parallel with the bottom panel, and is shaped to cover at least a portion of the bottom panel. First and second end panels are disposed at opposite ends of the top and bottom panels and are connected therewith to define a rigid, box-shaped case having a generally rigid bottom portion and a generally open back portion. First and second end panels have rear portions with a plurality of vertically spaced apart slots disposed therein. First and second hanger brackets each have a rear portion with first hooks shaped for reception in the slotted hangers of an associated one of the office furniture units, and a forward portion with second hooks selectively received in the slots in the rear portions of the first and second end panels to detachably support the case in a panel-hung condition against the outer face of the associated one of the office furniture units. An up-mount bracket has a lower portion shaped for connection with an associated one of the office furniture units, and an upper portion connected with and supporting the bottom portion of the case to detachably mount the case in an up-mounted condition above a top portion of the associated one of the furniture units. A removable back panel is shaped to enclose at least a portion of the open back portion of the case, and has side portions with outwardly protruding hooks selectively received in the slots in the rear portions of the first and second end panels to detachably connect the back panel with the case and enclose at least that portion of the open back portion of the case disposed above the top portion of the associated one of the office furniture units when the case is in the up-mounted condition.

Another aspect of the present invention is an office furniture unit having an outer face with slotted hangers extending therealong, and a removable storage unit assembly including a bottom panel operably positioned in a generally horizontal orientation along the office furniture unit, and a top panel disposed above and generally parallel with the bottom panel. First and second panels are disposed at opposite ends of the top and bottom panels and are connected therewith to define a rigid, box-shaped case having a generally open back portion. The first and second end panels have rear portions with a plurality of vertically spaced apart slots disposed therein. First and second hanger brackets each have a rear portion with first hooks selectively received in the slotted hangers of the office furniture units, and a forward portion with second hooks selectively received in the slots in the rear portions of the first and second end panels to detachably support the case in a panel-hung condition against the outer face of the office furniture unit.

Yet another aspect of the present invention is an office furniture unit, and a storage unit assembly including a bottom panel operably positioned in a generally horizontal orientation along the office furniture unit. A top panel is disposed above and generally parallel with the bottom panel. First and second end panels are disposed at opposite ends of the top and bottom panels and are connected therewith to define a rigid, box-shaped case having a generally rigid bottom portion and a generally open back portion. The first and second end panels have rear portions with a plurality of vertically spaced apart slots disposed therein. An up-mount bracket has a lower portion connected with the office furniture unit, and an upper portion connected with and supporting the bottom portion of the case to detachably mount the case in an up-mounted condition above a top portion of the furniture unit. A removable back panel encloses at least a portion of the open back portion of the case, and has side portions with outwardly protruding hooks received in the slots in the rear portions of the first and second end panels to detachably connect the back panel with the case and encloses at least that portion of the open back portion of the case disposed above the top portion of the office furniture unit.

Yet another aspect of the present invention is a method for making a storage unit assembly for office furniture units of the type having a like construction with slotted hangers extending along outer faces thereof including forming a bottom panel shaped to abuttingly support objects thereon. A top panel is formed in a shape to cover at least a portion of the bottom panel. The top panel is positioned in a generally parallel, spaced apart relationship with the bottom panel. First and second end panels are formed with rear portions having a plurality of vertically spaced apertures therein. The first and second end panels are positioned at opposite ends of the top and bottom panels and interconnected with the same to define a rigid, box-shaped case having a generally rigid bottom portion and a generally open back portion. First and second hanger brackets are formed, each having a rear portion with first hooks shaped for reception in the slotted hangers of a first selected one of the office furniture units, and a forward portion with second hooks shaped for reception in the slots in the rear portions of the first and second end panels. The first hooks on the first and second hanger brackets are inserted into the slotted hangers on the first selected furniture unit. The second hooks on the first and second hanger brackets are inserted into the slots in the rear portions of the first and second end panels to detachably support the case in a panel-hung condition against the outer face of the first selected office furniture unit. An up-mount bracket is formed with a lower portion shaped for connection with a second selected one of the office furniture units, and an upper portion shaped for connection with the bottom portion of said case. The lower portion of the up-mount bracket is mounted with the second selected furniture unit. The upper portion of the up-mount bracket is connected with the bottom portion of the case to detachably mount the case in an up-mounted condition above a top portion of the second selected furniture unit. A removable back panel is formed in a shape to enclose at least a portion of the open back portion of the case, and has side portions with outwardly protruding hooks shaped for reception in the slots in the rear portions of the first and second end panels. The hooks on the back panel are inserted into the slots in the rear portions of the first and second end panels to detachably connect the back panel with the case and enclose at least that portion of the open back portion of the case disposed above the top portion of the second selected office furniture unit when the case is in the up-mounted condition.

Yet another aspect of the present invention is to provide a storage unit assembly adapted to be secured to a variety of different types of furniture systems and which includes components that can be used in a wide variety of storage unit assemblies. The kit of parts associated with these storage unit assemblies is efficient in use, economical to manufacture, capable of a long operating life, and particularly adapted for its proposed use.

These and other features, advantages and objects of the present invention will be further understood and appreciated by those skilled in the art by reference to the following written specification, claims and appended drawings.

### BRIEF DESCRIPTION OF THE DRAWINGS

FIG. 1 is a top perspective view of one embodiment of a storage unit assembly of the present invention in a panel-hung condition;

FIG. 2 is an exploded perspective view of the storage unit assembly of FIG. 1;

FIG. 3 is a top perspective view of a storage unit assembly in an up-mounted condition;

FIG. 4 is an exploded perspective view of the storage unit assembly of FIG. 3;

FIG. 5 is a top perspective view of a bottom panel of the instant invention;

FIG. 6 is a top elevational view of the bottom panel of FIG. 5;

FIG. 7 is a rear elevational view of the bottom panel of FIG. 5;

FIG. 8 is a side elevational view of the bottom panel of FIG. 5;

FIG. 9 is a front elevational view of the bottom panel of FIG. 5;

FIG. 10 is a top perspective view of a back stop rail of the instant invention;

FIG. 11 is a side elevational view of the back stop rail of FIG. 10;

FIG. 12 is a front elevational view of the back stop rail of FIG. 10;

FIG. 13 is a back elevational view of the back stop rail of FIG. 10;

FIG. 14A is a front perspective view of the bottom panel connected with a back stop rail;

FIG. 14B is a bottom panel attached to the back stop rail and an accessory mounted thereto;

FIG. 15 is a top perspective view of a connector bracket of the instant invention;

FIG. 16 is a first side elevational view of the connector bracket of FIG. 15;

FIG. 17 is a second side elevational view of the connector bracket of FIG. 15;

FIG. 18 is a top elevational view of the connector bracket of FIG. 15;

FIG. 19 is a front elevational view of the connector bracket of FIG. 15;

FIG. 20 is a top perspective view of an end panel of the instant invention;

FIG. 21A is a first side elevational view of the end panel of FIG. 20;

FIG. 21B is a second side elevational view of the end panel of FIG. 20;

FIG. 22 is a top elevational view of the end panel of FIG. 20;

FIG. 23 is a bottom elevational view of the end panel of FIG. 20;

FIG. 24 is a rear elevational view of the end panel of FIG. 20;

FIG. 25A is a top perspective view of an end panel attached to a connector bracket;

FIG. 25B is a first side elevational view of the end panel and connector bracket of FIG. 25A;

FIG. 26 is a side elevational view of the bottom panel during connection with an end panel;

FIG. 27 is a side elevational view of the bottom panel connected with an end panel;

FIG. 28 is an enlarged elevational view of a portion of the connector bracket connected to the bottom panel;

FIG. 29 is a top perspective view of a top panel of the present invention;

FIG. 30 is a side elevational view of the top panel of FIG. 29;

FIG. 31 is a top elevational view of the top panel of FIG. 29;

FIG. 32 is a bottom elevational view of the top panel of FIG. 29;

FIG. 33A is a top perspective view of the bottom panel, end panels and top panel assembled;

FIG. 33B is a front elevational view of the bottom panel, end panels and top panel assembled;

FIG. 34 is a top perspective view of a removable back of the instant invention;

FIG. 35 is a side elevational view of the removable back of FIG. 34;

FIG. 36A is a top elevational view of the removable back of FIG. 34;

FIG. 36B is a bottom elevational view of the removable back of FIG. 34;

FIG. 37 is a front elevational view of removable back of FIG. 34;

FIG. 38 is a top perspective view of a metal door of the instant invention;

FIG. 39 is a side elevational view of the metal door of FIG. 38;

FIG. 40 is a front elevational view of the metal door of FIG. 38;

FIG. 41 is a rear elevational view of the metal door of FIG. 38;

FIG. 42 is a top perspective view of a wood door of the instant invention;

FIG. 43 is a side elevational view of the wood door of FIG. 42;

FIG. 44 is a front elevational view of the wood door of FIG. 42;

FIG. 45 is a rear elevational view of the wood door of FIG. 42;

FIG. 46 is a top perspective view of a curved front door of the instant invention;

FIG. 47 is a side elevational view of the curved front door of FIG. 46;

FIG. 48 is a front elevational view of the curved front door of FIG. 46;

FIG. 49 is a rear elevational view of the curved front door of FIG. 46;

FIG. 50 is a top perspective view of a picture frame door of the instant invention;

FIG. 51 is a side elevational view of the picture frame door of FIG. 50;

FIG. 52 is a front elevational view of the picture frame door of FIG. 50;

FIG. 53 is a rear elevational view of the picture frame door of FIG. 50;

FIG. 54 is a top perspective view of an over-the-case storage unit assembly of the instant invention in a closed position;

FIG. 55 is an enlarged view of section LV of the over-the-case storage unit assembly of FIG. 54;

FIG. 56 is a top perspective view of an over-the-case storage unit assembly of the instant invention in an open position;

FIG. 57 is an enlarged view of section LVII of the over-the-case storage unit assembly of FIG. 56;

FIG. 58 is rear elevational view of an over-the-case door;

FIG. 59 is a partial rear elevational view of an over-the-case door;

FIG. 60 is a side elevational view of an over-the-case door;

FIG. 61 is a bottom perspective view of a door slide with quick attach clip for the over-the-case door;

FIG. 62 is a bottom perspective view of a door slide in a nearly fully open position;

FIG. 63 is a bottom elevational view of the door slide of FIG. 62;

FIG. 64 is a bottom perspective view of a door slide for the over-the-case application in an nearly fully closed position;

FIG. 65 is a top perspective view of an in-the-case storage unit assembly of the instant invention in a closed position;

FIG. 66 is a top perspective view of an in-the-case storage unit assembly with the door in an open position;

FIG. 67 is side elevational view of an in-the-case guide rail of the instant invention;

FIG. 68 is a top perspective view of the in-the-case guide rail of FIG. 67;

FIG. 69 is a top perspective view of the in-the-case guide rail of FIG. 67 mounted in an end panel;

FIG. 70A is a rear elevational view of an in-the-case door of the instant invention;

FIG. 70B is a partial bottom perspective view of the in-the-case door of FIG. 70 between open and closed positions;

FIG. 71A is an enlarged perspective view of a dampener assembly;

FIG. 71B is a partial side elevational view of the in-the-case door dampener with the door closed;

FIG. 71C is a partial side elevational view of the in-the-case door dampener with the door partially opened;

FIG. 71D is a partial side elevational view of the in-the-case door dampener with the door open;

FIG. 72 is a bottom elevational view of an anti-racking mechanism attached to a metal door;

FIG. 73 is a bottom elevational view of the anti-racking mechanism of FIG. 72 in a partially extended position;

FIG. 74A is a top perspective view of an anti-racking mechanism prior to installation;

FIG. 74B is a top perspective view of the anti-racking mechanism of 74A after installation;

FIG. 75 is a bottom perspective view of the anti-racking mechanism of FIG. 74A after installation;

FIG. 76A is a side elevational view of the anti-racking mechanism attached;

FIG. 76B is an enlarged view of section LXXVIB of FIG. 76A;

FIG. 77 is a top perspective view of the anti-racking mechanism between fully open and fully closed positions;

FIG. 78 is a top perspective view of the anti-racking mechanism in the fully closed position;

FIG. 79 is a top perspective view of an integral end panel of the instant invention;

FIG. 80 is a top elevational view of the integral end panel of FIG. 79;

FIG. 81 is a first side elevational view of the integral end panel of FIG. 79;

FIG. 82 is a bottom elevational view of the integral end panel of FIG. 79;

FIG. 83 is a second side elevational view of the integral end panel of FIG. 79;

FIG. 84 is a top perspective view of a storage unit assembly with integral end panels prior to installation;

FIG. 85 is a side elevational view of a storage unit assembly with integral end panels after installation;

FIG. 86 is a top perspective view of an on-module hanger bracket of the instant invention;

FIG. 87 is a first side elevational view of the on-module hanger bracket of FIG. 86;

FIG. 88 is a top elevational view of the on-module hanger bracket of FIG. 86;

FIG. 89 is a rear elevational view of the on-module hanger bracket of FIG. 86;

FIG. 90 is a second side elevational view of the on-module hanger bracket of FIG. 86;

FIG. 91 is a front elevational view of the on-module hanger bracket of FIG. 86;

FIG. 92 is a top perspective view of a storage unit assembly of the instant invention prior to being installed in a panel-hung condition with hanger brackets;

FIG. 93 is a top perspective view of a storage unit assembly of the instant invention prior to being installed in a panel-hung condition with hanger brackets installed;

FIG. 94 is a side elevational view of a storage unit assembly of the instant invention prior to being installed in a panel-hung condition with hanger brackets installed;

FIG. 95 is a partial rear perspective view of a storage unit assembly of the instant invention prior to being panel-hung with hanger brackets;

FIG. 96 is a top perspective view of a storage unit assembly in an on-module panel-hung condition;

FIG. 97A is a side elevational view of the storage unit assembly in an on-module panel-hung condition;

FIG. 97B is a rear exploded perspective view of an end panel; hanger bracket; and anti-dislodgement clip;

FIG. 97C is a rear perspective view of an end panel engaged with a hanger bracket and anti-dislodgement clip;

FIG. 98 is a top perspective view of an off-module support bracket of the present invention;

FIG. 99 is an enlarged partial perspective view of a top portion of the off-module support bracket of FIG. 98;

FIG. 100 is a front elevational view of the off-module support bracket of FIG. 98;

FIG. 101 is a rear elevational view of the off-module support bracket of FIG. 98;

FIG. 102 is a bottom elevational view of the off-module support bracket of FIG. 98;

FIG. 103 is a side elevational view of the off-module support bracket of FIG. 98;

FIG. 104 is an enlarged partial side elevational view of the bottom portion of the off-module support bracket of FIG. 98;

FIG. 105 is a top perspective view of a storage unit assembly of the instant invention prior to being panel hung in a vertical off-module condition;

FIG. 106 is a side elevational view of a storage unit assembly prior to being panel hung in a vertical off-module condition;

FIG. 107A is a side elevational view of a storage unit assembly of the instant invention in a panel hung off-module condition;

FIG. 107B is an enlarged side elevational view of a storage unit assembly of the instant invention in a panel hung off-module condition;

FIG. 107C side elevational view of a storage unit assembly of the instant invention in a panel hung off-module condition;

FIG. 108 is a top perspective view of a top bracket of a horizontal off-module support bracket of the instant invention;

FIG. 109 is a front elevational view of the top bracket of FIG. 108;

FIG. 110 is a rear elevational view of the top bracket of FIG. 108;

FIG. 111 is a side elevational view of the top bracket of FIG. 108;

FIG. 112 is a bottom elevational view of the top bracket of FIG. 108;

FIG. 113 is a top perspective view of a bottom bracket of a horizontal off-module support bracket of the instant invention;

FIG. 114 is a front elevational view of the bottom bracket of FIG. 113;

FIG. 115 is a bottom elevational view of the bottom bracket of FIG. 113;

FIG. 116 is a side elevational view of the bottom bracket of FIG. 113;

FIG. 117 is a back elevational view of the bottom bracket of FIG. 113;

FIG. 118 is a top elevational view of the bottom bracket of FIG. 113;

FIG. 119 is a top perspective view of a storage unit assembly of the instant invention prior to being panel hung in a horizontal off-module condition;

FIG. 120 is a side elevational view of a storage unit assembly of the instant invention prior to being panel hung in a horizontal off-module condition;

FIG. 120A is a bottom elevational view of a bottom bracket during installation;

FIG. 121 is a front perspective view of horizontal off-module support brackets engaged with slotted hangers of office furniture unit prior to connection with vertical off-module support bracket;

FIG. 122 is a rear perspective view of horizontal off-module support brackets engaged with slotted hangers of office furniture unit prior to connection with vertical off-module support bracket;

FIG. 123 is a side elevational view of a vertical off-module bracket engaging a horizontal off-module bracket;

FIG. 124 is a side elevational view of a vertical off-module bracket engaged with a horizontal off-module bracket;

FIG. 125 is a side elevational view of a storage unit assembly of the instant invention before installation in a panel hung horizontal off-module condition;

FIG. 126 is a top perspective view of a storage unit assembly of the instant invention in a panel hung horizontal off-module condition;

FIG. 127 is a top perspective view of an up-mount bracket of the instant invention;

FIG. 128 is a top elevational view of the up-mount bracket of FIG. 127;

FIG. 129 is a side elevational view of the up-mount bracket of FIG. 127;

FIG. 130 is a rear elevational view of the up-mount bracket of FIG. 127;

FIG. 131 is a top perspective view of a storage unit assembly of the instant invention prior to installation in an up-mounted condition;

FIG. 132 is a side elevational view of a storage unit assembly of the instant invention prior to installation in an up-mounted condition;

FIG. 133A is a side elevational view of a storage unit assembly of the instant invention in an up-mounted condition;

FIG. 133B is a front elevational view of a storage unit assembly in a desk/service module arrangement;

FIG. 134 is a top perspective view of a storage unit assembly of the instant invention in an up-mounted condition;

FIG. 135 is a top perspective view of a lock assembly of the instant invention;

FIG. 136 is a top elevational view of the lock assembly of FIG. 135;

FIG. 137 is a front elevational view of the lock assembly of FIG. 135;

FIG. 138 is a side elevational view of the lock assembly of FIG. 135;

FIG. 139 is a top elevational view of the lock assembly installed in a bottom panel;

FIG. 140 is a top perspective view of a dual door top panel of the present invention;

FIG. 141 is a bottom elevational view of the dual door top panel of FIG. 140;

FIG. 142 is a front elevational view of a dual door support of the present invention;

FIG. 143 is an exploded top perspective view a dual door storage unit of the present invention;

FIG. 144 is a top perspective view of a shelf bracket of the instant invention;

FIG. 145 is a front elevational view of the shelf bracket of FIG. 144;

FIG. 146 is a first side elevational view of the shelf bracket of FIG. 144;

FIG. 147 is a top elevational view of the shelf bracket of FIG. 144;

FIG. 148 is a second side elevational view of the shelf bracket of FIG. 144;

FIG. 149 is an exploded top perspective view of the shelf prior to installation;

FIG. 150 is a top perspective view of the shelf of FIG. 149 installed;

FIG. 151 is a top perspective view of a shelf with end walls of the instant invention;

FIG. 152 is a front elevational view of the shelf of FIG. 151;

FIG. 153 is a first side elevational view of the shelf of FIG. 151;

FIG. 154 is a top elevational view of the shelf of FIG. 151;

FIG. 155 is a second side elevational view of the shelf of FIG. 151;

FIG. 156 is an exploded top perspective view of the shelf with end walls of the instant invention;

FIG. 157 is a top perspective view of the shelf with end walls installed;

FIG. 158 is a top perspective view of a binder bin with a support vertical strut installed;

FIG. 159 is a top perspective view of a support strut;

FIG. 160 is a side elevational view of the support strut of FIG. 159;

FIG. 160A is an enlarged side elevational view of section CLXA of FIG. 160;

FIG. 161 is a rear elevational view of the support strut FIG. 159;

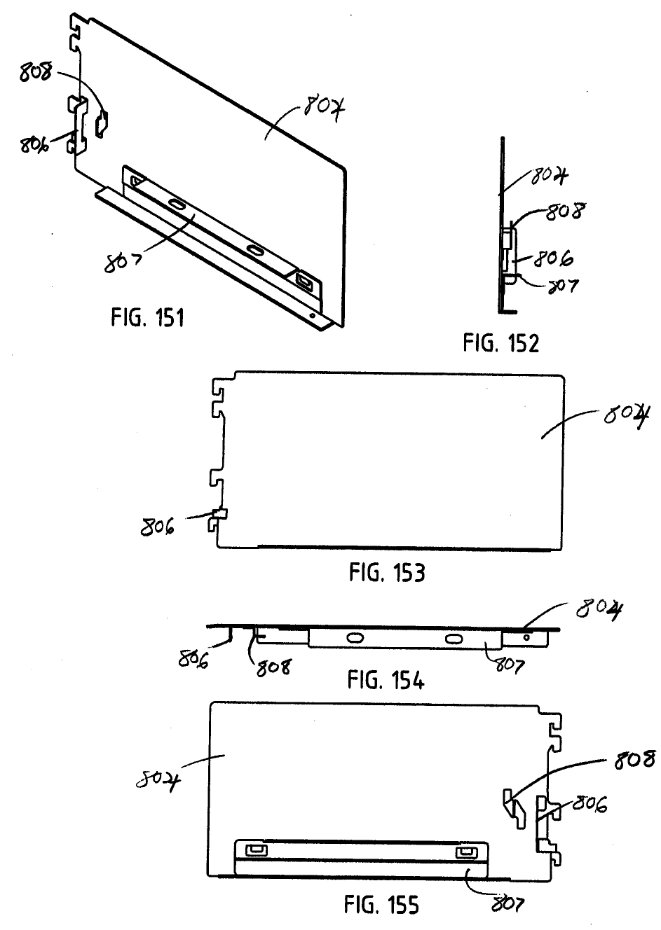

FIG. 152 is a top perspective view of a binder bin with a temporary strut installed;

FIG. 163 is a top perspective view of a temporary strut;

FIG. 164 is a side elevational view of the temporary strut of FIG. 163;

FIG. 164A is an enlarged side elevational view of section CLXIVA of FIG. 164; and

FIG. 165 is a rear elevational view of the temporary vertical strut FIG. 163.

### DETAILED DESCRIPTION OF THE PREFERRED EMBODIMENTS

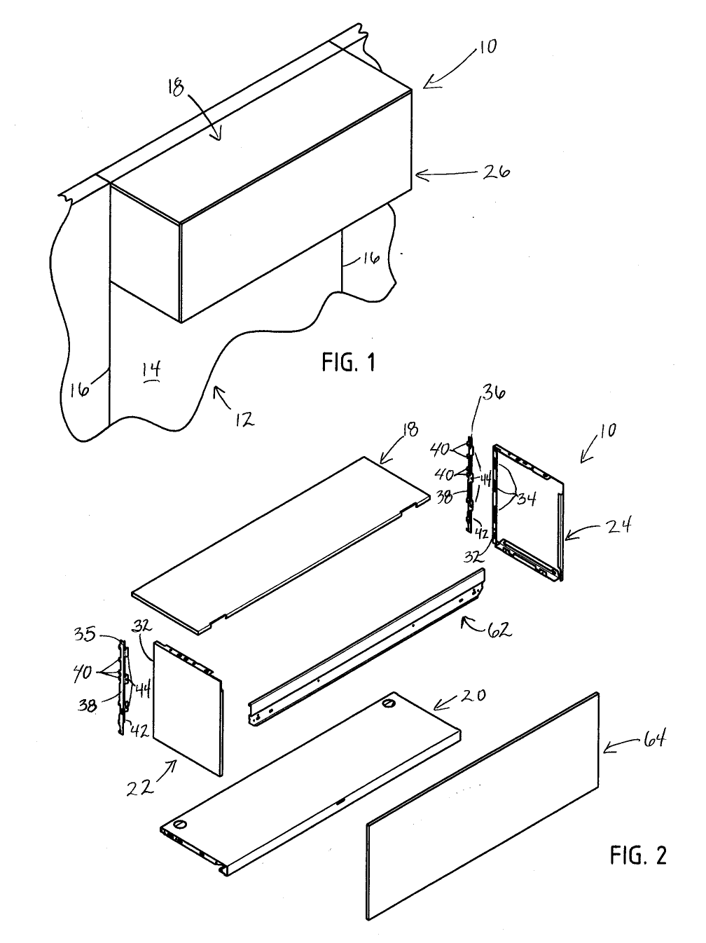

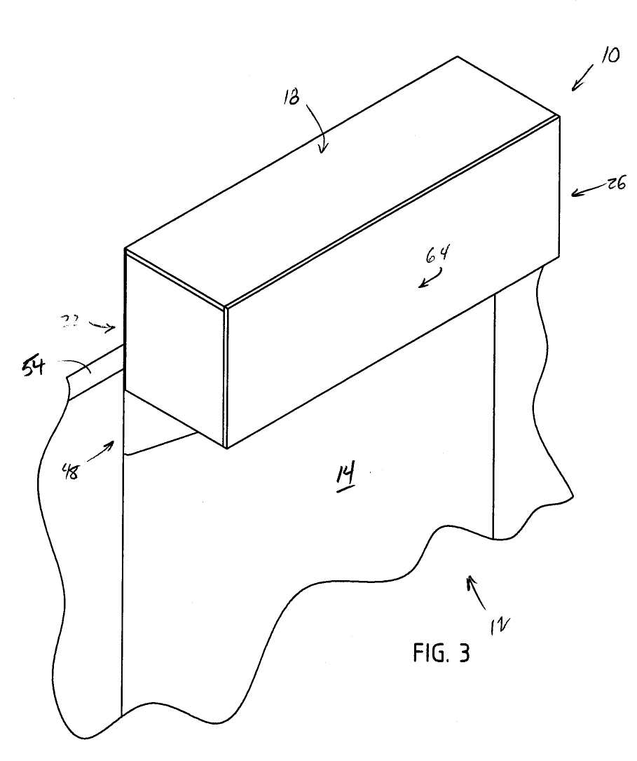

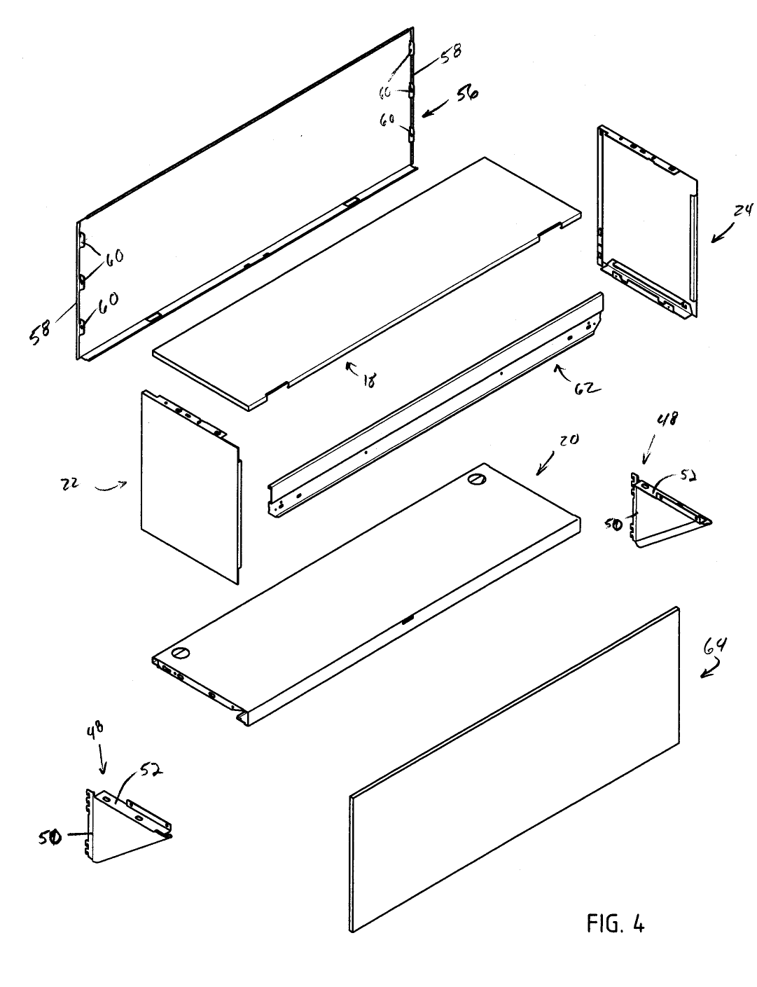

For purposes of description herein the terms “upper”, “lower”, “right”, “left”, “rear”, “front”, “vertical”, “horizontal” and derivatives thereof shall relate to the invention as oriented in FIGS. 1-4. However, it is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

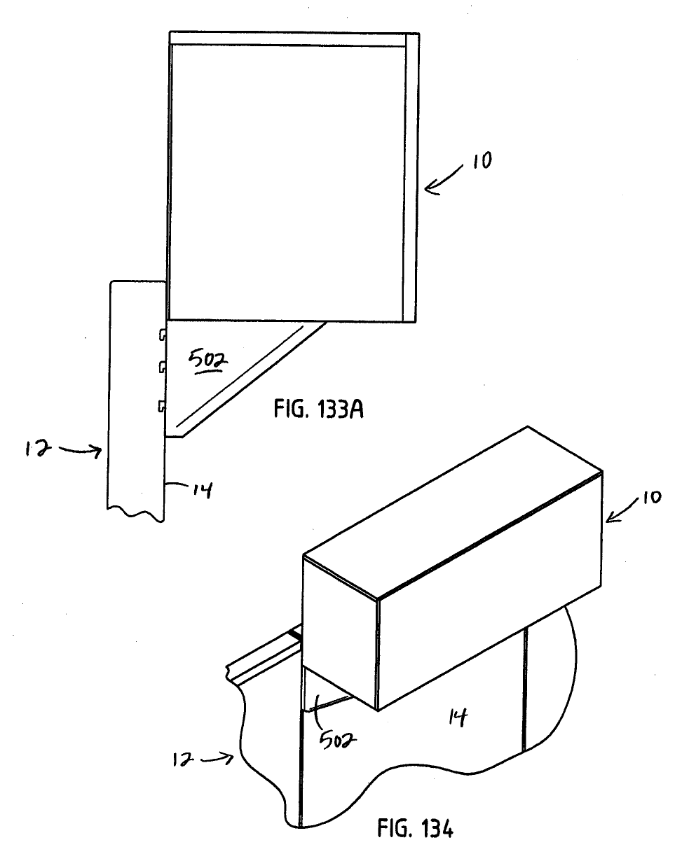

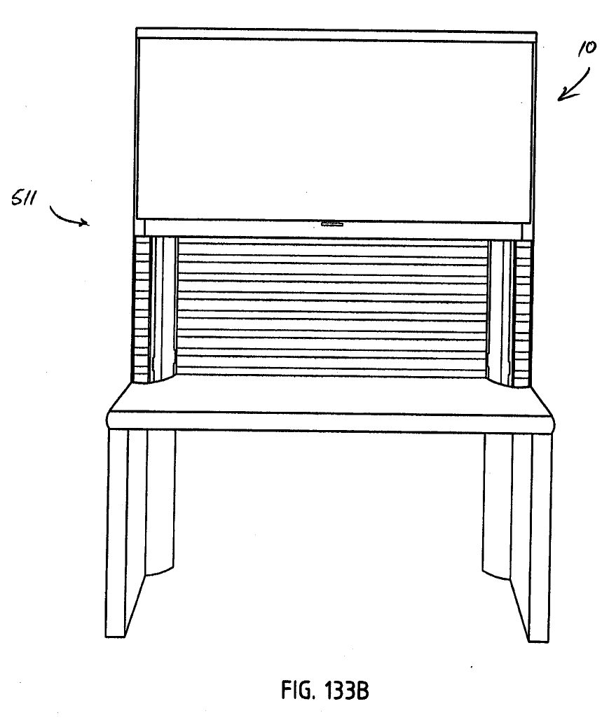

The reference numeral 10 (FIG. 1) generally designates a storage unit assembly for office furniture units 12 of the type having an outer face 14 with slotted hangers 16 extending therealong. The storage unit 10 includes a bottom panel 20 operably positioned in a generally horizontal orientation, and shaped to abuttingly support objects thereon, and a top panel 18 disposed above and generally parallel with the bottom panel 20, and shaped to cover at least a portion of the bottom panel 20. First and second end panels 22, 24 are disposed at opposite ends of the top and bottom panels 18, 20 and connected with the top and bottom panels 18, 20 to define a rigid, box-shaped case 26 having a generally rigid bottom portion 28 and a generally open back portion 30. The first and second end panels 22, 24 have rear portions 32 with a plurality of vertically spaced apart slots 34 disposed therein. First and second hanger brackets 35, 36 each have a rear portion 38 with first hooks 40 shaped for reception in the slotted hangers 16 of an associated one of the office furniture units 12 and a forward portion 42 with second hooks 44 selectively received in the slots 34 in the rear portions 32 of the first and second end panels 22, 24 to detachably support the case 26 in a panel-hung condition against the outer face 14 of the associated one of the office furniture units 12, as shown in FIGS. 133 and 134. An up-mount bracket 48 has a lower portion 50 shaped for connection with an associated one of the office furniture units 12, and an upper portion 52 connected with and supporting the bottom portion of the case 26 to detachably mount the case 26 in an up-mounted condition above a top portion 54 of the associated one of the furniture units 12. A removable back panel 56 is shaped to enclose at least a portion of the open back portion 30 of the case 26 and has side portions 58 with outwardly protruding hooks 60 selectively received in the slots 34 in the rear portions 32 of the first and second end panels 22, 24 to detachably connect the back panel 56 with the case 26 and enclose at least that portion of the open back portion 30 of the case 26 disposed above the top portion 54 of the associated one of the office furniture units 12 when the case 26 is in the up-mounted condition (FIGS. 133 and 134).

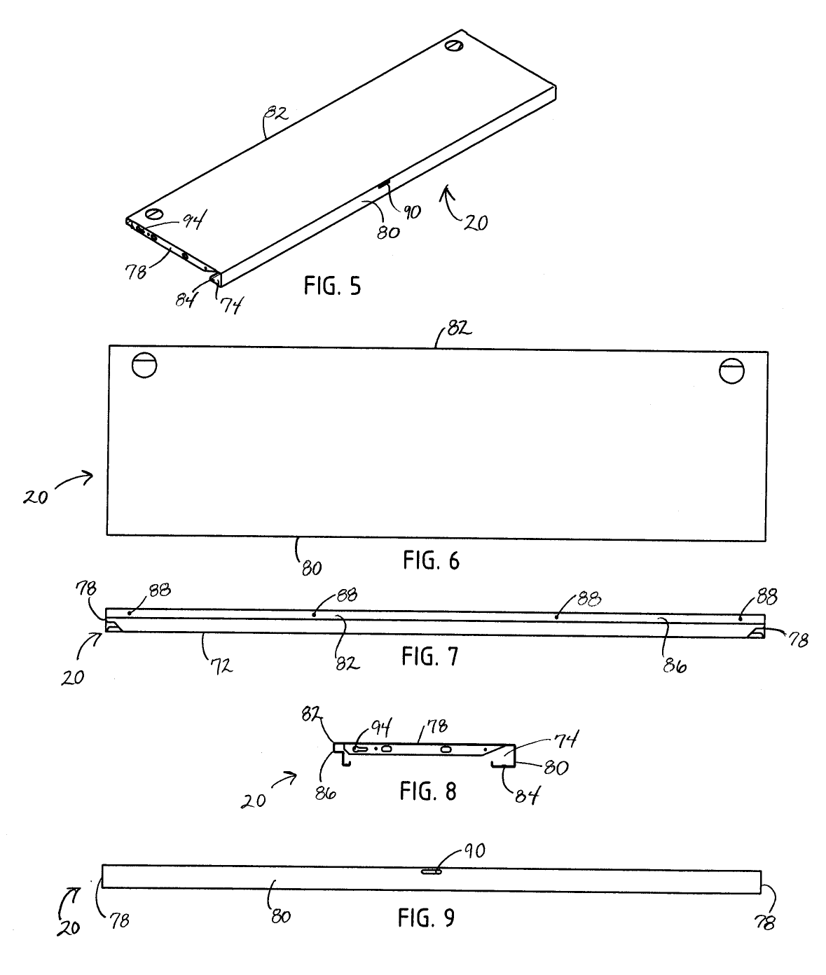

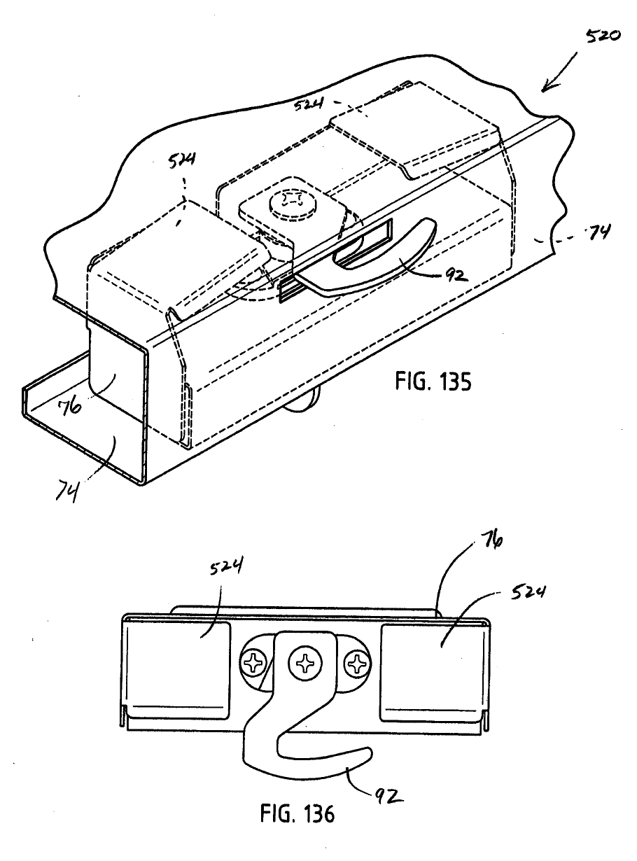

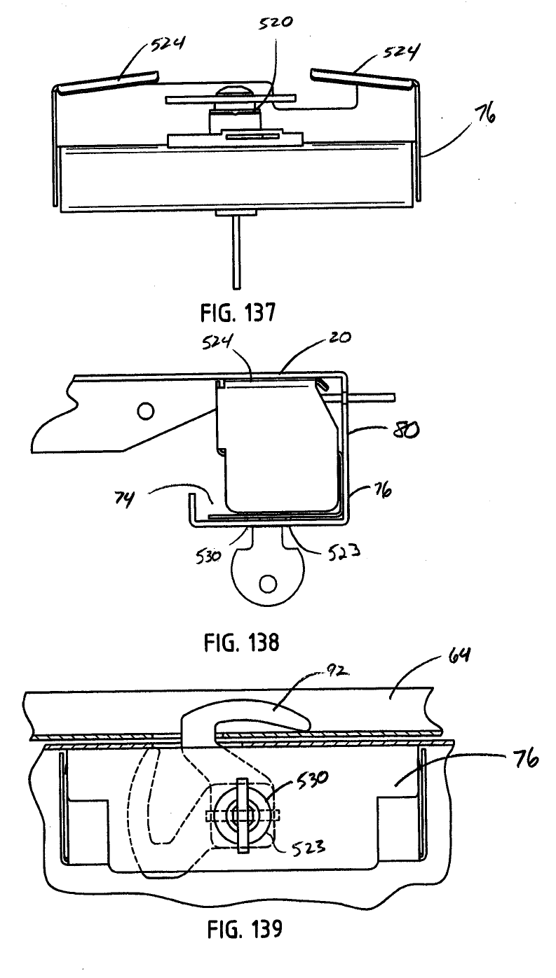

In the example shown in FIGS. 5-9, bottom panel 20 includes a substantially planar top surface 70 adapted to support objects thereon and a bottom surface 72 including a socket 74 adapted to engage and secure a lock housing 76 therein, as will be described later in FIGS. 135-139. Bottom panel 20 further includes side walls 78, as well as a front portion 80 and back portion 82. Socket 74 is defined by the bottom surface 72, front portion 80 and a socket flange 84. Back portion 82 of bottom panel 20 includes a downwardly extending flange 86 shaped to abut and connect with back stop rail 62. Fastener apertures 88 in the back portion 82 of bottom panel 20 as well as in back stop rail 62 allow back stop rail 62 to be fastened to the back portion 82 of bottom panel 20 by mechanical fasteners. The front portion 80 of bottom panel 20 includes a lock aperture 90 that allows a lock arm 92 to protrude from and be received in bottom panel 20. The side walls 78 of bottom panel 20 include a key hole slot 94 adapted for engagement with a tab 96 on a connector bracket 98 that secures the first and second end panels 22, 24 to bottom panel 20.

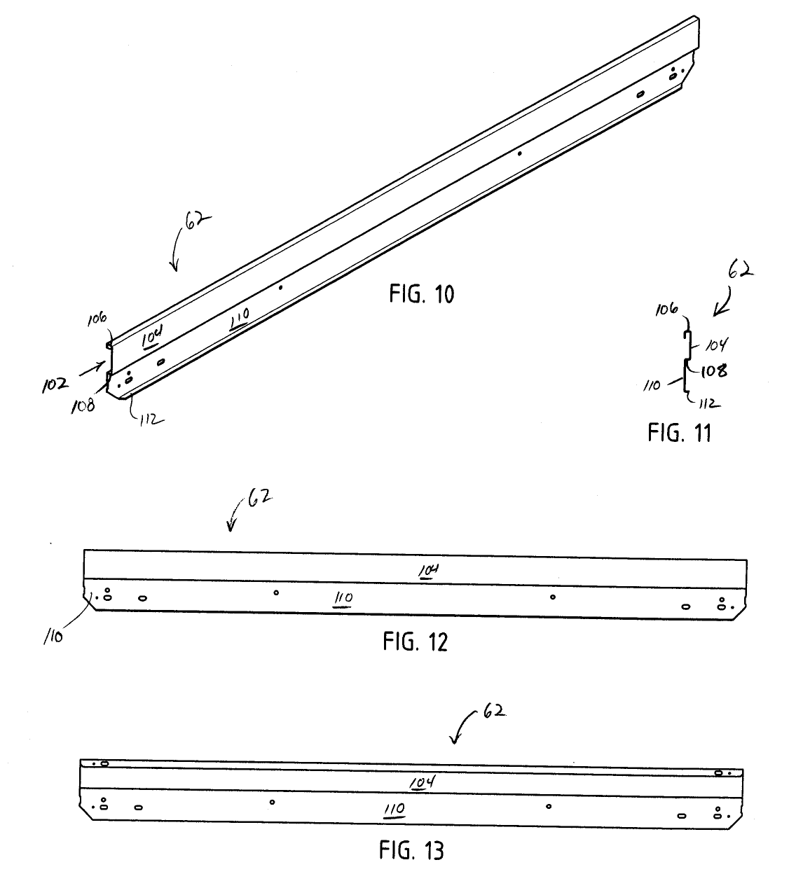

Referring to FIGS. 10-13, 14A and 14B, the illustrated case 26 includes an elongate, rigid, channel-shaped back stop rail 62 that connects with rail brackets 100 (FIGS. 25A and 25B) attached to the first and second end panels 22, 24, as disclosed in greater detail in related application Ser. No. ______, filed ______, entitled STORAGE UNIT BACK STOP AND METHOD. The back stop rail 62 provides rigidity to the case and is designed to support accessories that can be hung therefrom including dividers, small shelves, communication/electrical line manager, etc. The back stop rail 62 extends between the first and second end panels 22, 24 in the interior of the case 26. The back stop rail 62 has a rearwardly opening, generally U-shaped upper portion 102 defined by a generally flat upper vertical web 104 with upper and lower horizontal flanges 106, 108 projecting rearwardly from the top and bottom of the vertical web 104. Back stop rail 62 also includes a lower portion 110 that extends below bottom panel 20 and terminates at an inwardly extending base flange 112. Back stop rail 62 is supported along the back portion 82 of bottom panel 20 by fasteners and the vertical web 104 projects inwardly into the interior of the case 26 to retain objects on bottom panel 20.

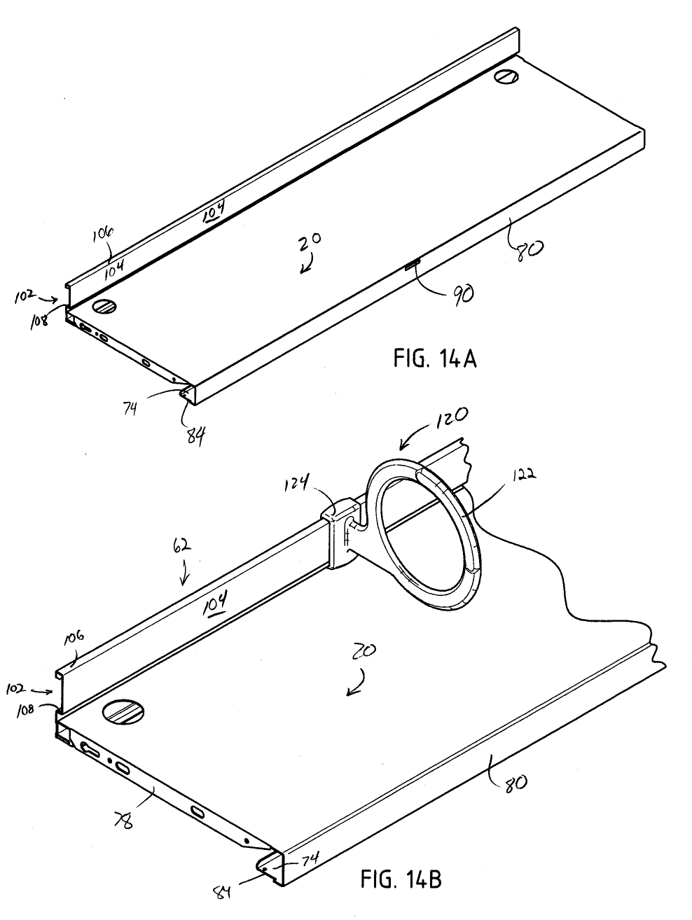

As shown in FIG. 14A, an accessory 120 may be provided having a first portion 122 configured to equip the interior of the case 26 and a second portion 124 detachably engaged with the upper horizontal flange 106 on the back stop rail 62. The accessory 120 hangs from and is supported by and abuts against vertical web 104 of said back stop rail 62 at a selected one of a wide variety of positions along back stop rail 62. The accessory 120 functions an interior divider inside the bin and also functions as a wire manager through which communication/electrical lines can be routed.

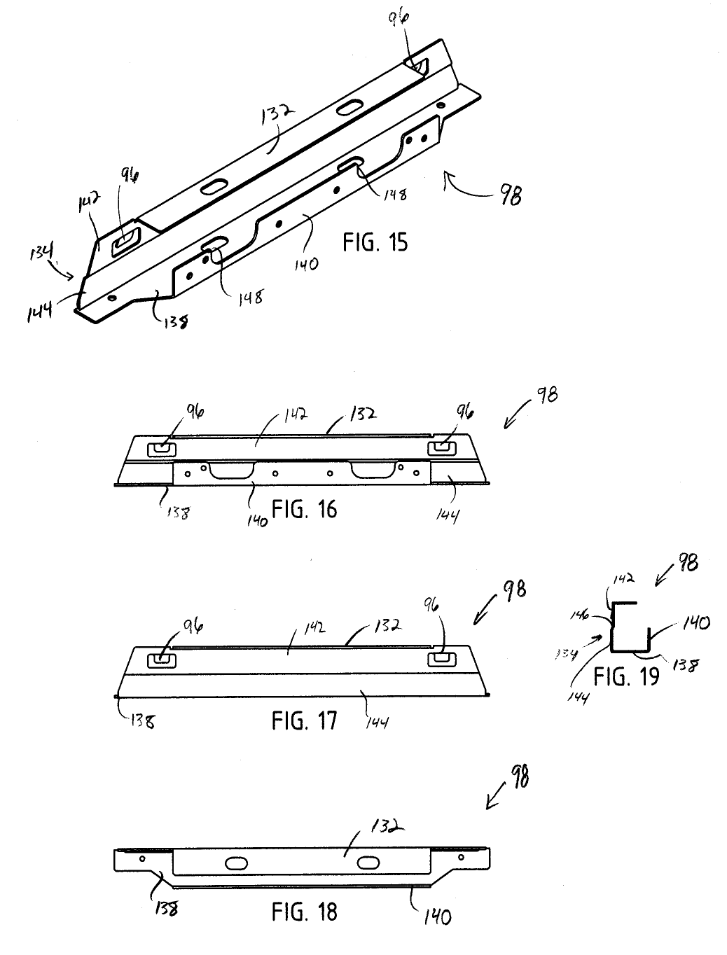

As shown in FIGS. 15-19, the illustrated connector bracket 98 includes a top support flange 132, a side engagement wall 134 having engagement tabs 96, a bottom support flange 138, and an upwardly extending flange 140. Side engagement wall 134 includes an upper portion 142 offset from a lower portion 144. This construction of connector bracket 98 provides a small gap 146 between upper portion 142 of side engagement wall 134 and end panel 22 or 24 to which connector bracket 98 is attached. This small gap 146 allows side wall 78 of bottom panel 20 to be frictionally forced into gap 146. Top support flange 132 is of adequate length to support the underside of bottom panel 20. Bottom support flange 138 of connector bracket 98 includes apertures 148 adapted for reception of fasteners when storage unit assembly 10 has been secured in an up-mounted condition.

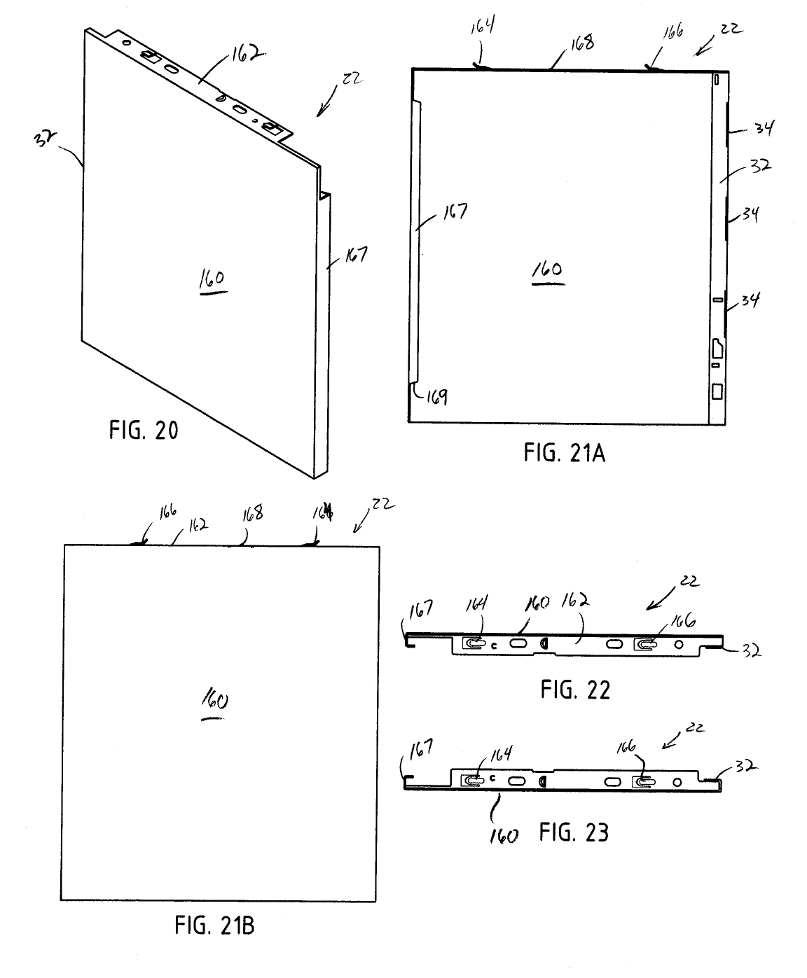

Referring now to FIGS. 20-24, first end panel 22 includes a substantially planar exterior wall 160 with a top flange 162 extending orthogonally inward toward the interior of storage unit assembly 10 after construction. The second end panel 24 will have identical features only oriented in a mirror-like fashion. Accordingly, all features described with respect to the first end panel 22 will be mirror images to that of the second end panel 24. Top flange 162 includes first and second clips 164, 166 adapted to receive a portion of top panel 18 as will be disclosed in further detail below. A detent stop 168 is located between first and second clips 164, 166 and helps secure top panel 18 in position when installed. A front flange 167 on the end panel includes a bottom end 169 adapted to abut and secure the top surface of bottom panel 20 after assembly. Rear portion 32 of first end panel 22 includes multiple slots 34, adapted to engage either the removable back 56 in an up-mounted condition or a hanger bracket 35, 36 when the storage unit assembly 10 is installed in a panel hung condition as discussed in further detail below.

FIGS. 25A and 25B illustrate connector bracket 98 attached with first end panel 22. Connector bracket 98 may be attached to the inside of first end panel 22 by fasteners, welding etc. The attachment of connector bracket 98 is such that gap 146 is created between upper portion 142 of side engagement wall 134 and the inside of first end panel 22.

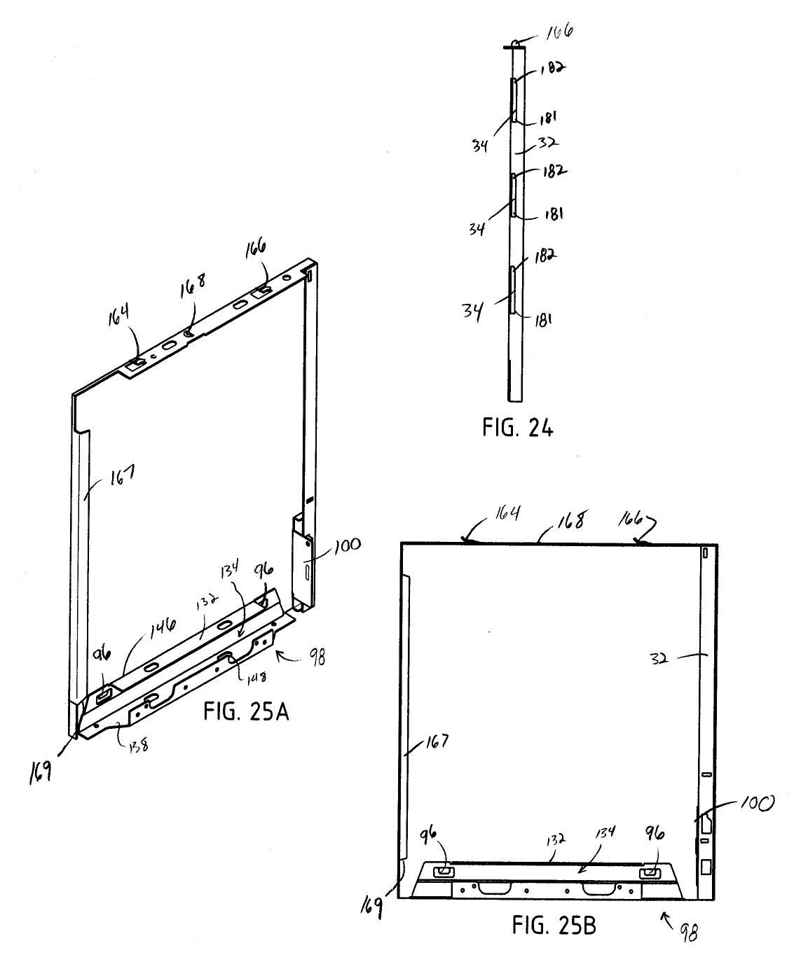

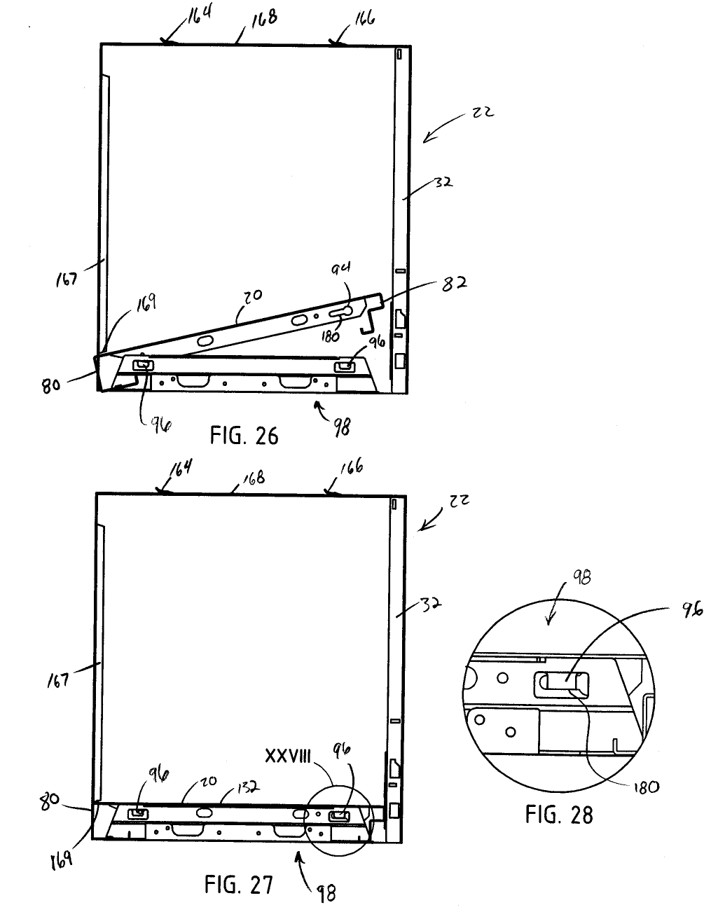

Referring now to FIGS. 26-28, each end panel 22, 24 is connected to bottom panel 20 by connector brackets 98. During assembly, front portion 80 of bottom panel 20 is slid forward at an angle so that front portion 80 of bottom panel 20 is below bottom end 169 of front flange 167 of first end panel 22, as shown in FIG. 26. Back portion 82 of bottom panel 20 is then rotated downwardly so that key hole slot 94, located on both side portions of bottom panel 20, engages the rearmost engagement tab 96 on connector brackets 98 located on either side of bottom panel 20, as shown in FIG. 27. When the rearmost engagement tab 96 reaches key hole slot 94, it springs outwardly into interference with a bottom edge 180 of key hole slot 94, as shown in FIGS. 27 and 28, preventing bottom panel 20 from being accidentally lifted or removed. During disassembly, to remove bottom panel 20, a user would utilize a prying device, such as a screwdriver, and push the rearmost engagement tab 96 in a direction toward the first end panel 22 thereby preventing interference with bottom edge 180 of key hole slot 94 so that back portion 82 of bottom panel 20 can be rotated upwardly and bottom panel 20 can be slid out from between the first and second end panels 22, 24. There are three slots 34 (FIG. 24) each of which has a shaped adapted receive the hooks 44 of hanger brackets 35, 36. The slots 34 include a wide base 181 that narrows to an acute top portion 182 and are aligned vertically with one another.

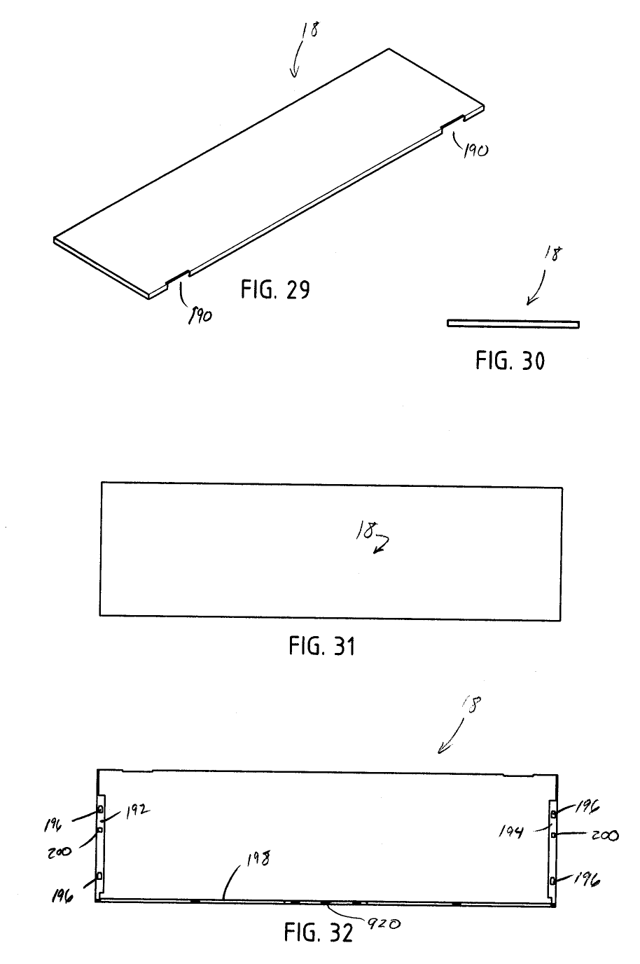

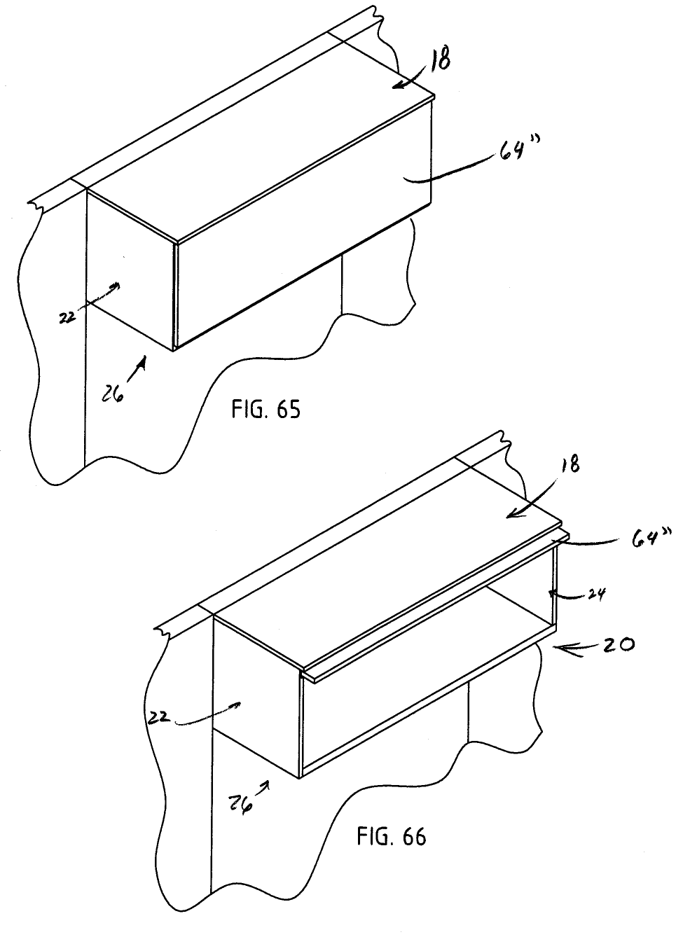

In the example shown in FIGS. 29-32, top panel 18 includes cutouts 190 adapted to receive a portion of a hinge for an over-the-case configuration. For an in-the-case configuration (FIGS. 65 and 66), the cutouts 190 would likely not be present. Top panel 18 is substantially planar and includes an underside with first and second inwardly extending side flanges 192, 194 having clip apertures 196 disposed therein, as well as an inwardly extending rear flange 198. The clip apertures 196 are adapted to engage first and second clips 164, 166 on end panels 22, 24. A central aperture 200 is adapted to engage detent stop 168 that exists between first and second clips 164, 166 on end panels 22, 24. Top panel 18 is slid onto the clips 164, 166 until detent stop 168 engages central aperture 200, at which point top panel 18 is held in position and cannot be removed. A prying tool, such as a screwdriver, can be used to separate inwardly extending side flanges 192, 194 of top panel 18 from end panels 22, 24 so that top panel 18 can be withdrawn from connection with end panels 22, 24.

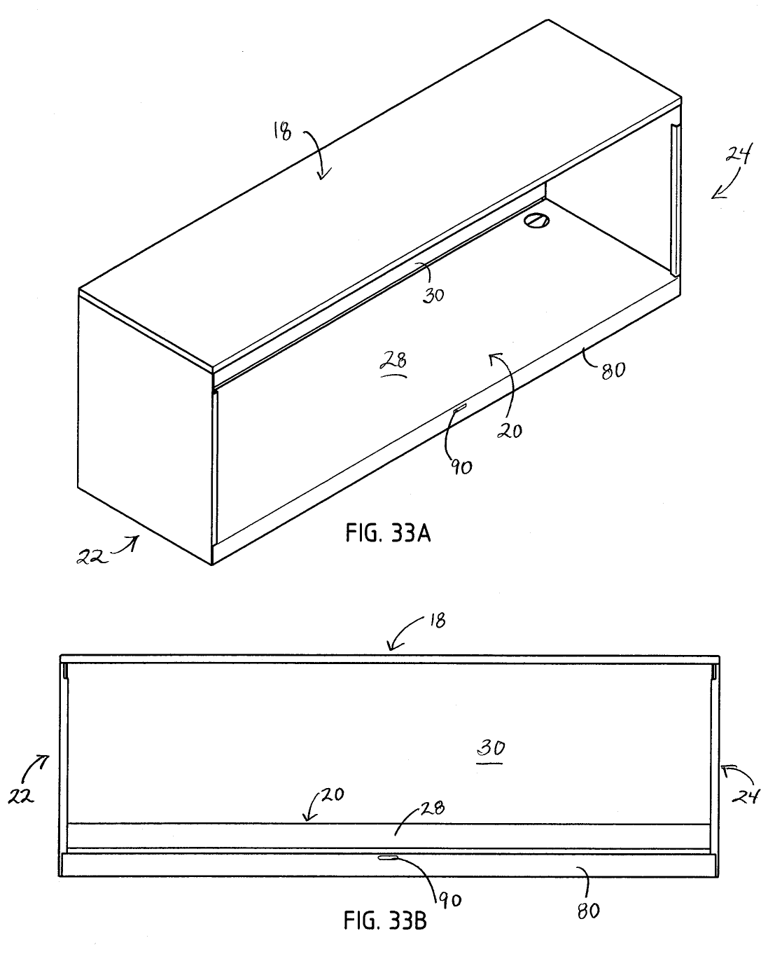

Referring to FIGS. 33A and 33B, the assembly of first and second end panels 22, 24 with top and bottom panels 18, 20 defines the rigid box-shaped case 26 with a generally rigid bottom portion 28 and a generally open back portion 30.

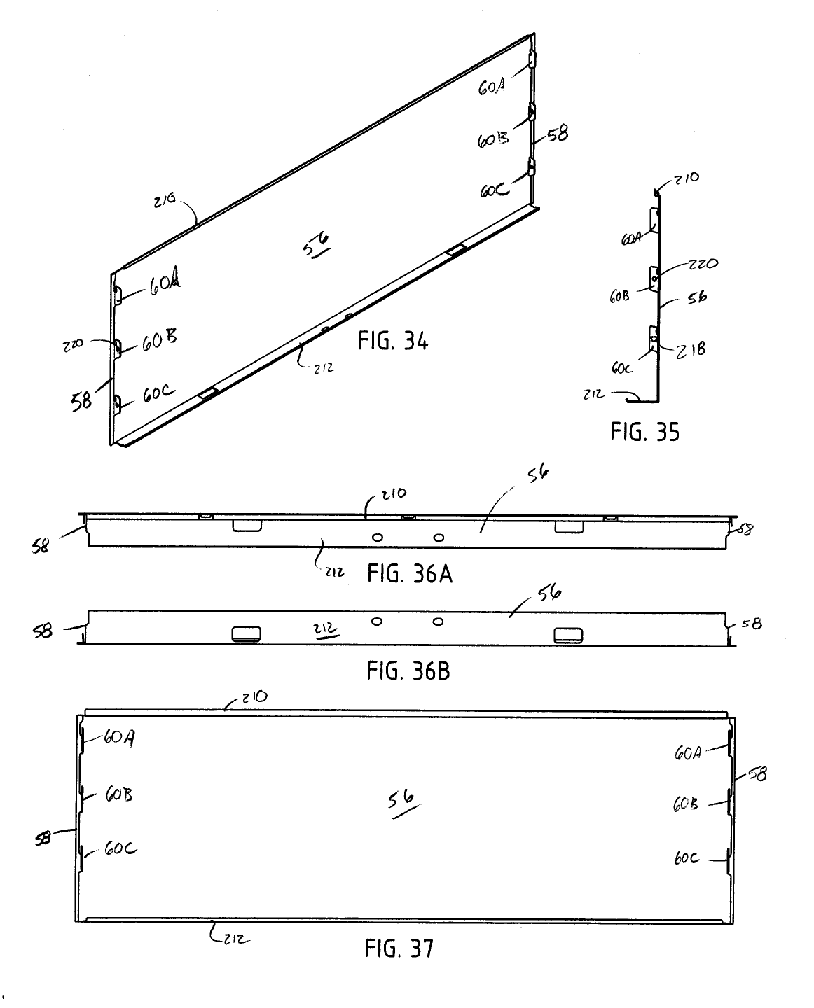

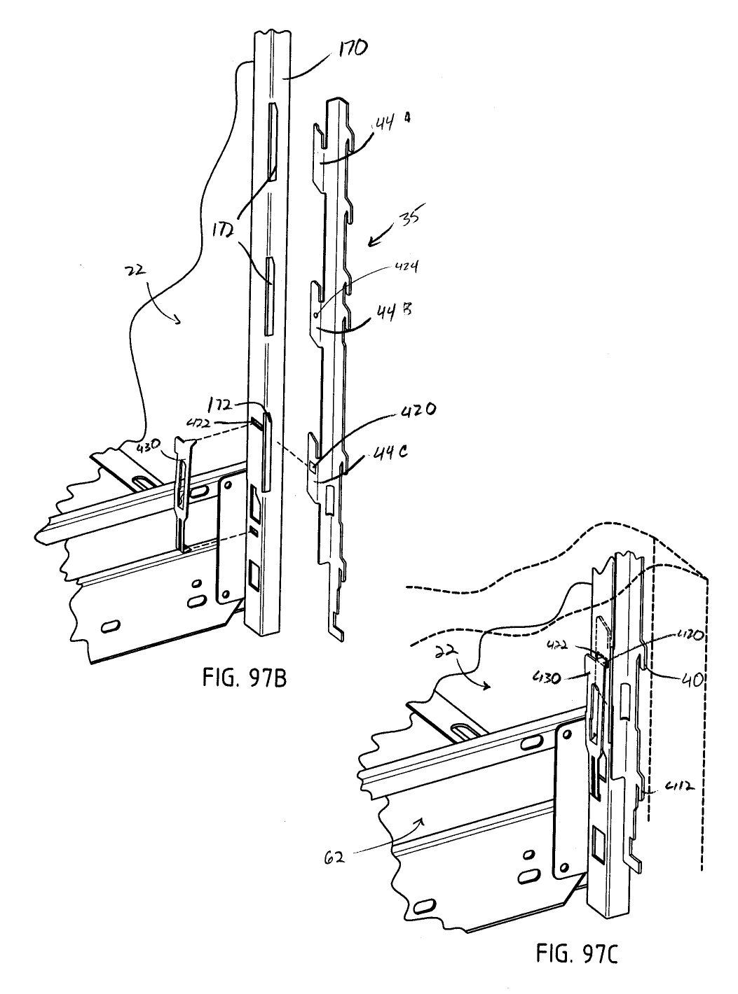

As shown in FIGS. 34-37, the illustrated removable back panel 56 includes a top engagement flange 210, a bottom engagement flange 212, and top hooks 60A, middle hooks 60B and bottom hooks 60C (collectively referred to as hooks 60) that protrude outwardly from side portions 58 in a direction generally orthogonal to the planar extent of the removable back panel 56. Hooks 60 of removable back panel 56 are designed for engagement with slots 34 in the rear portion 32 of each of the first and second end panels 22, 24. The bottom hook 60C on each side of back panel 56 includes an anti-dislodgment aperture 218 designed for engagement with an anti-dislodgement clip located on each of the first and second end panels 22, 24 (shown in FIGS. 97B and 97C) in a similar fashion to that described below with respect to hook 44C of connector brackets 35, 36. In addition the middle hook 60B on each side of back panel 56 includes an anti-dislodgement aperture 220 for receiving an optional anti-dislodgement pin. The hooks 60 have a shape and size very similar to the shape and size of hooks 44 on hanger brackets 35, 36. The three hooks 60A, 60B and 60C are aligned vertically on both side portions 58 of the removable back 56 and are adapted to engage the three vertical slots 34. The back panel 56 is typically installed onto case 26 when the case is to be secured in an up-mounted condition.

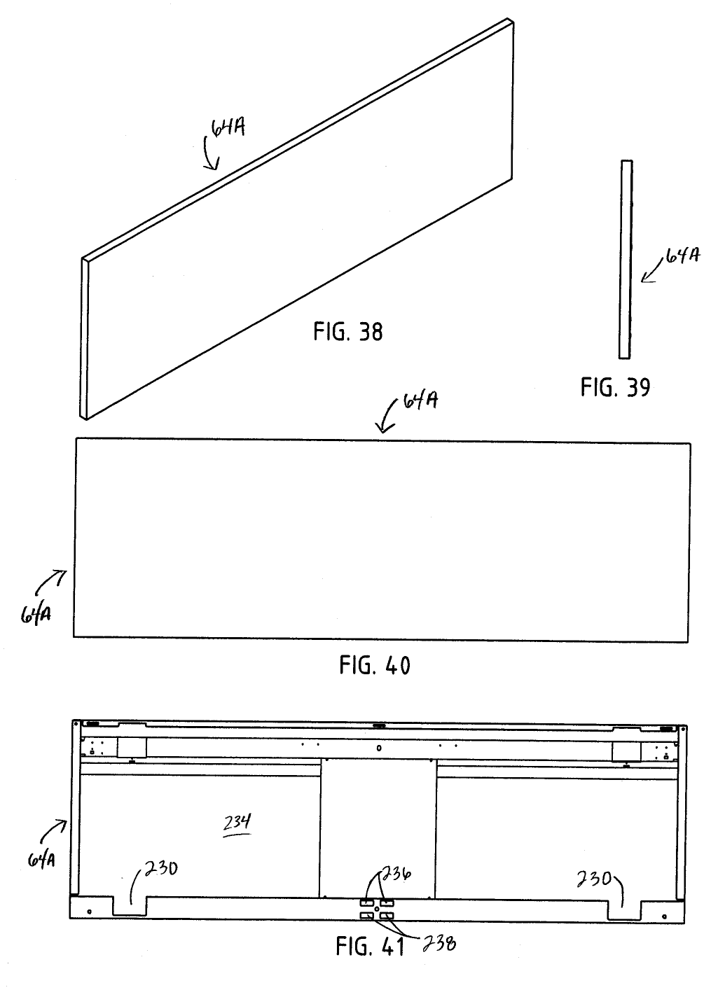

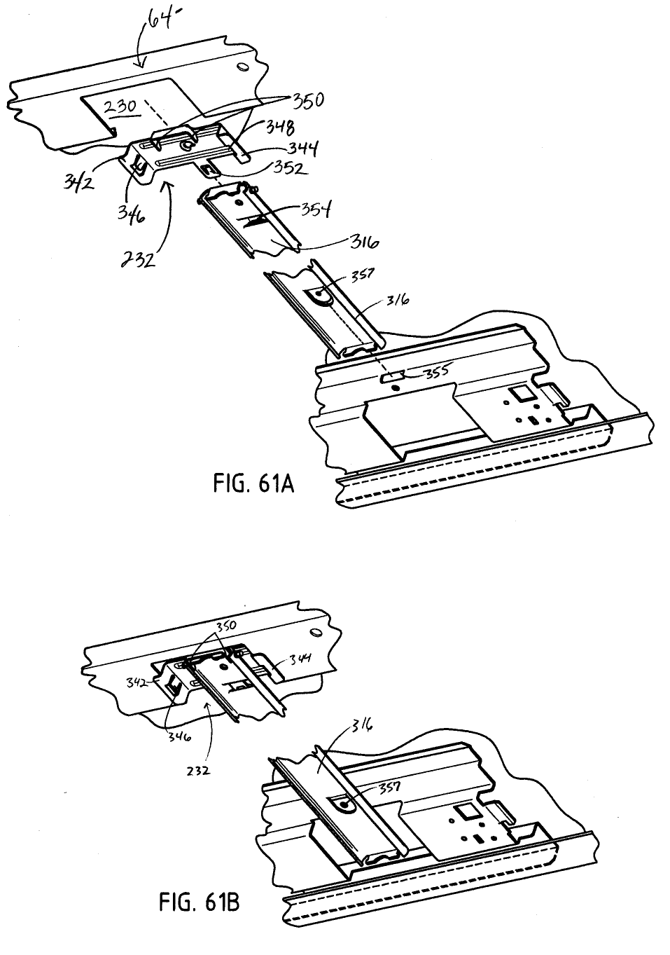

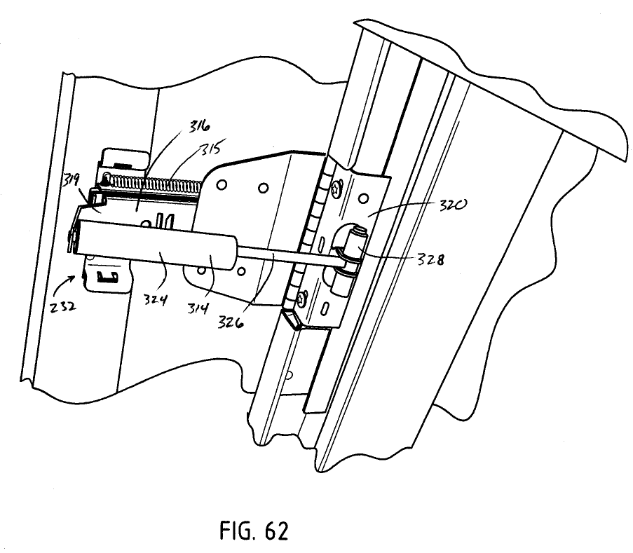

Referring now to FIGS. 38-53, the storage unit assemblies are adapted for use with metal doors 64A, wood doors 64B, curved front doors 64C and picture frame doors 64D. The metal doors 64A shown in FIGS. 38-41 are substantially planar and include slide cutouts 230 adapted to receive quick attach clips 232, as shown in FIG. 61, that hold slide assemblies in place in an over-the-case application. A back side 234 of the metal door 64A also includes two sets of lock apertures 236, 238 adapted to receive and retain locking arm 92 in a locking housing 76. The top set of apertures 236 is used for a short case construction and the bottom set of apertures 238 is used for a tall case construction. Doors may be installed on the storage unit assembly in a variety of ways, including those disclosed in U.S. Provisional Application Ser. No. 60/940,899, filed May 30, 2007, entitled STORAGE UNIT DOOR APPARATUS AND METHOD, which is hereby incorporated by reference.

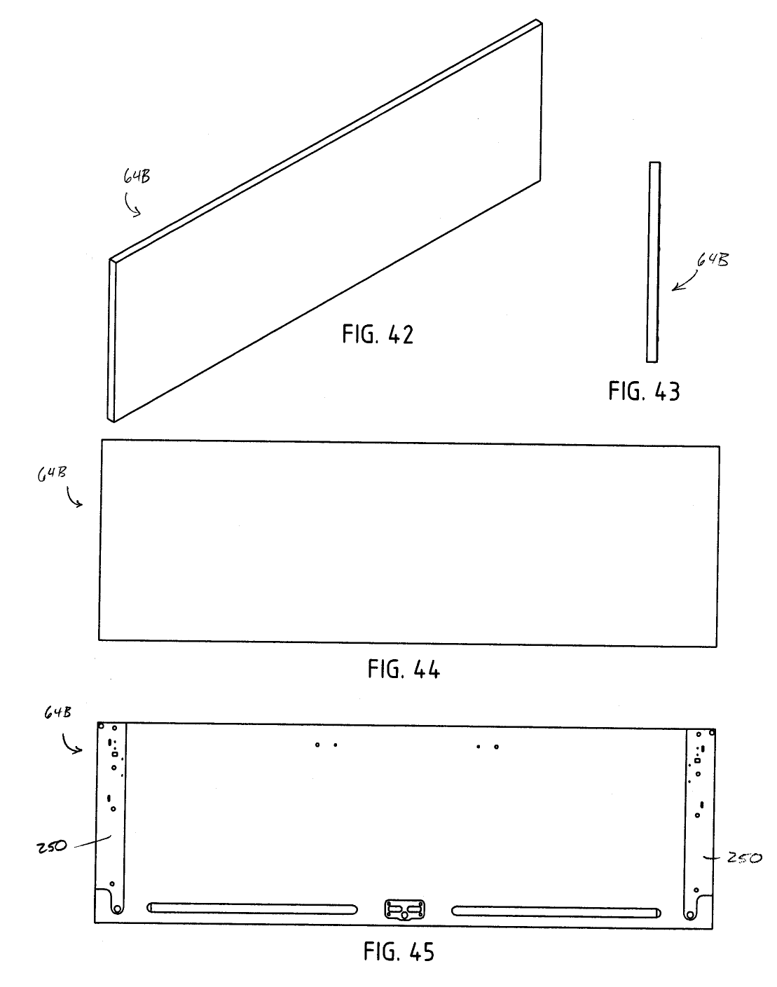

FIGS. 42-45 illustrate wood door 64B, which is similar in construction to the metal door 64A described above, but is solid wood, and includes metal side reinforcements 250. Wood door 64B is adapted for use in an in-the-case application, although it is contemplated that wood door 64B could be used in an over-the-case application as well.

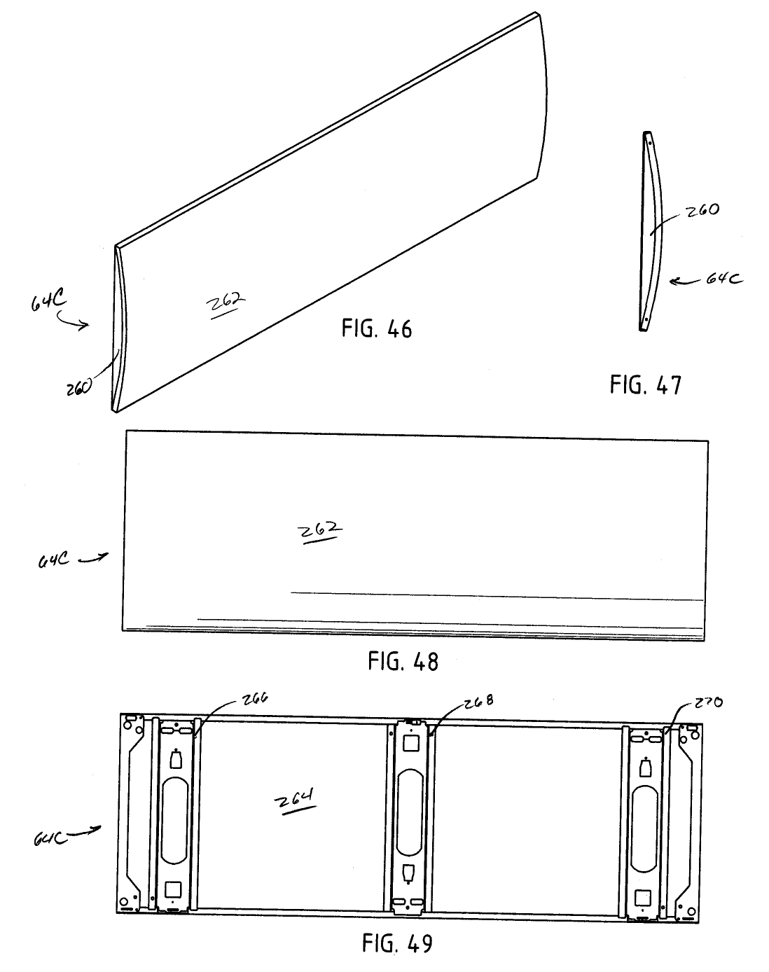

FIGS. 46-49 illustrate curved front door 64C having side walls 260 and a curved front side 262. A back side 264 of the curved front door 64C includes three bracket assemblies 266, 268, 270. The central bracket assembly 268 provides structural support while the side brackets 266 and 270 are adapted to connect with slide assemblies in an over-the-case application.

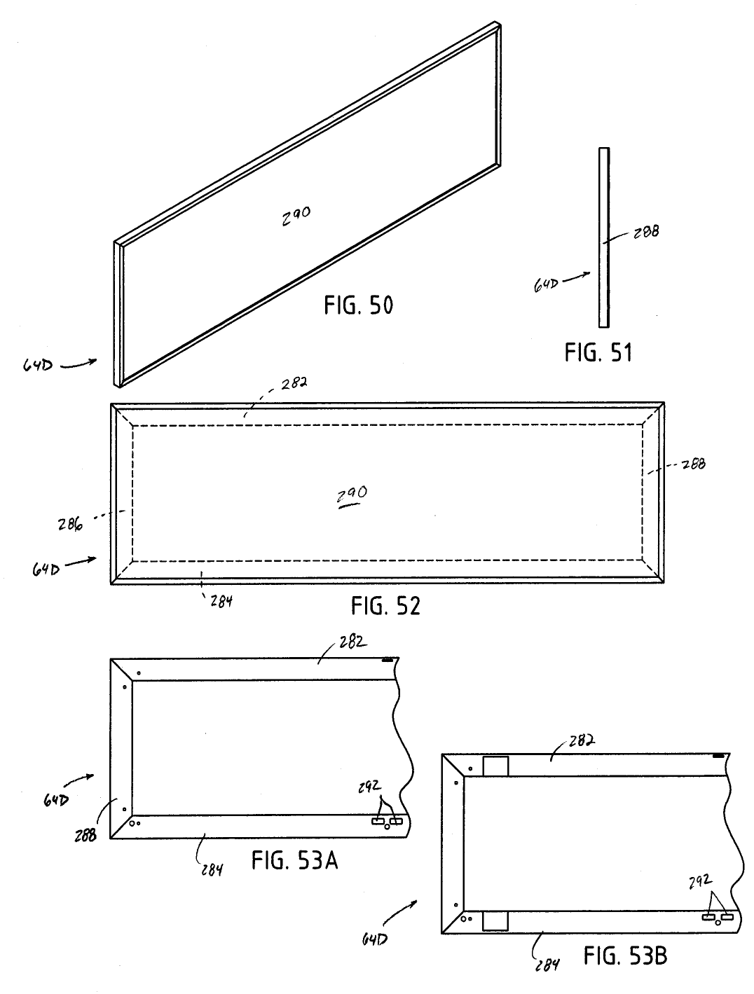

Referring now to FIGS. 50-52, 53A and 53B, picture frame door 64D includes a frame construction 280 having a top member 282, bottom member 284, and side members 286, 288 configured to frame a planar sheet 290. The planar sheet 290 may be a marker board, translucent or opaque material, or a solid material, for example. Picture frame door 34D also includes a set of lock apertures 292 for installation on storage unit assemblies in either an over-the-case (FIG. 53B) or in-the-case application (FIG. 53A). The over-the-case picture frame door 64D also includes slide cutouts for receiving a slide mechanism.

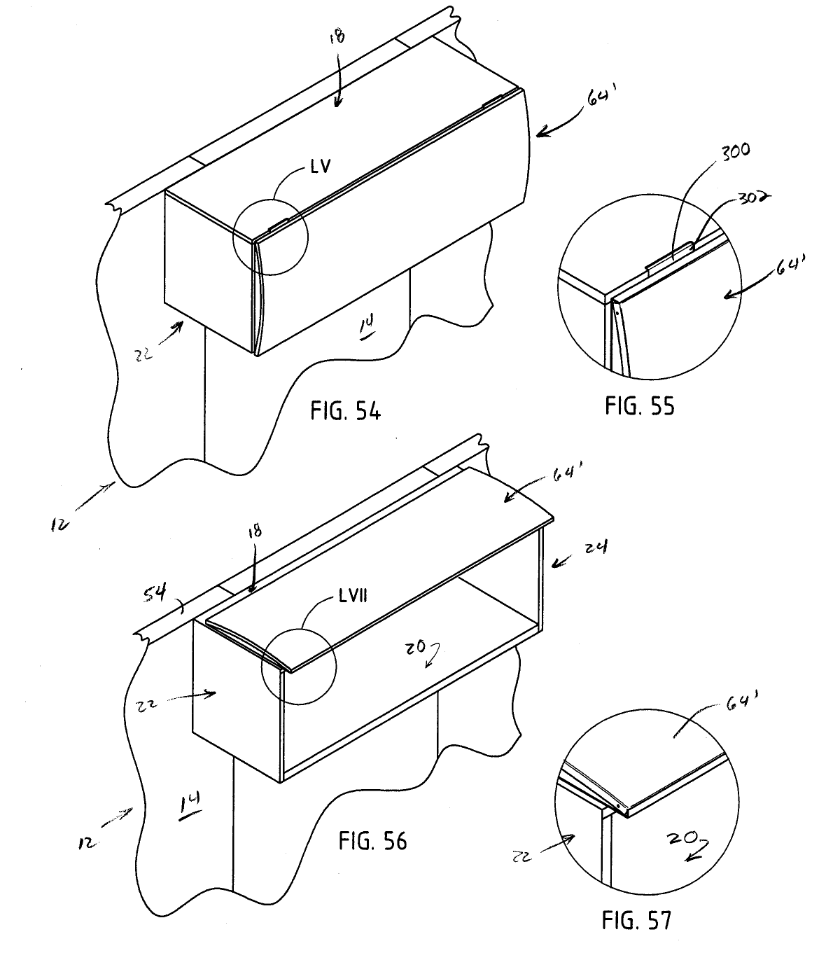

Referring now to FIGS. 54-57, the metal door 64A, wood door 64B, curved front door 64C or picture frame door 64D may be used as an over-the-case door 64′ for an over-the-case configuration or application. The door 64′ is connected to a planar attachment bracket 300 in the cutouts 190 in the top panel 18 and not directly to the front portion of the top panel 18. As a result, a reduced gap 302 is created. In the over-the-case construction, the door 64′ can be moved from a vertical closed position to a horizontal open position where the door 64′ rests on the top panel 18.

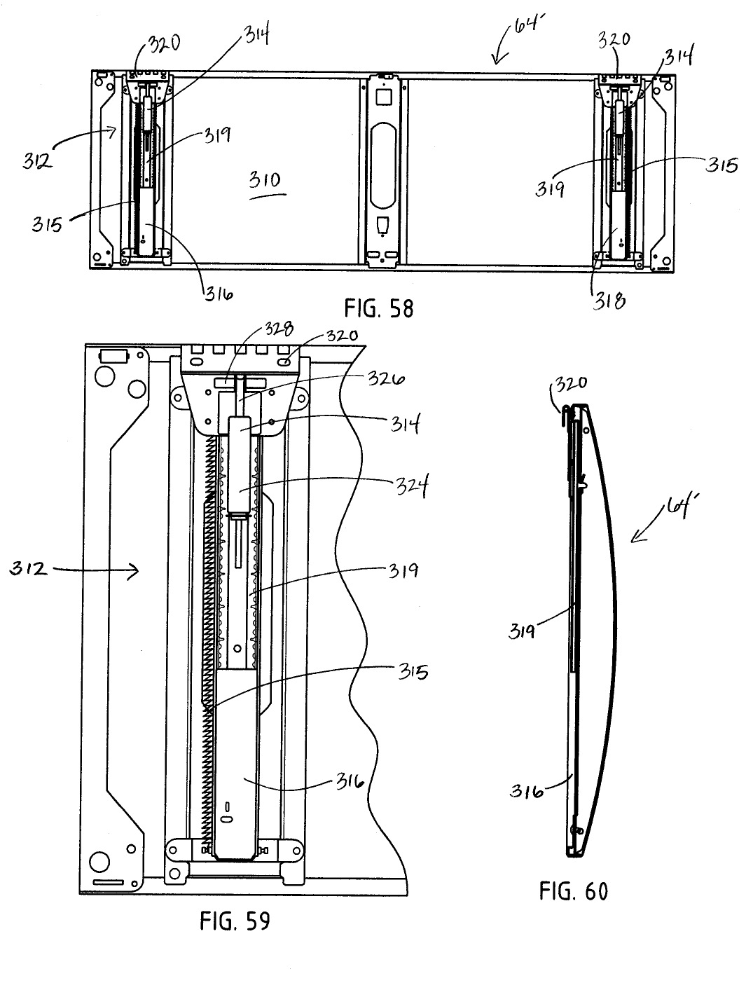

In the example shown in FIGS. 58-60, a rear side portion 310 of the over-the-case door 64′ includes an over-the-case door support mechanism 312 having optional dampener assemblies 314 and optional spring assists 315 connected with first and second door slides 316, 318. Door slides 316, 318 are attached rear side 310 of door 64′ and to hinges 320 located at the inside top of door 64′ and each door slide 316, 318 includes a carriage 319. The hinges 320 allow door 64′ to move between open and closed positions. The slides 316, 318 allow relative movement of door 64′ to an open position above storage unit assembly 10 and to a closed vertical position in front of storage unit assembly 10. As shown in FIG. 59, the dampener assembly 314 has a piston 324 and a spring cylinder 326. Piston 324 is biased outward from the spring cylinder 326, and acts to slow movement of the over-the-case door 64′ during closure. Piston 324 is attached to a pivot pin 328 disposed below and further inside the case 26 than hinges 320. Spring assists 315 secured on either side of the dampener assembly 314 act to assist the user during opening of the over-the-case door 64′.

FIGS. 61A and 61B illustrate the quick attach clip 232 that may be used to secure door slides 316, 318 to door 64′. The quick attach clip 232 includes first and second wings 342, 344 with first and second tabs 346, 348, respectively, designed to provide an interference fit with slide cutouts 230 in the over-the-case door 64′. Legs 350 extend into the slides 316, 318 and hold the slide in position. A center tab 352 extends and locks into a loop 354 on slide 316 keeping slide 316 from slipping out of quick attach clip 232. Both slides 316 and 318 may be attached in the manner described above. A door-side engagement tab 353 on track is selectively received in a tab receiving aperture 355 (FIG. 61B) in a hat channel near the top of interior side of door 64′. Engagement tab 353 includes a fastener aperture 357 for receiving a mechanical fastener that can be secured through both engagement tab 353 and hat channel of door 64′. Alternatively, as shown in FIG. 62, a permanent bracket 356 with fasteners 358 may be used.

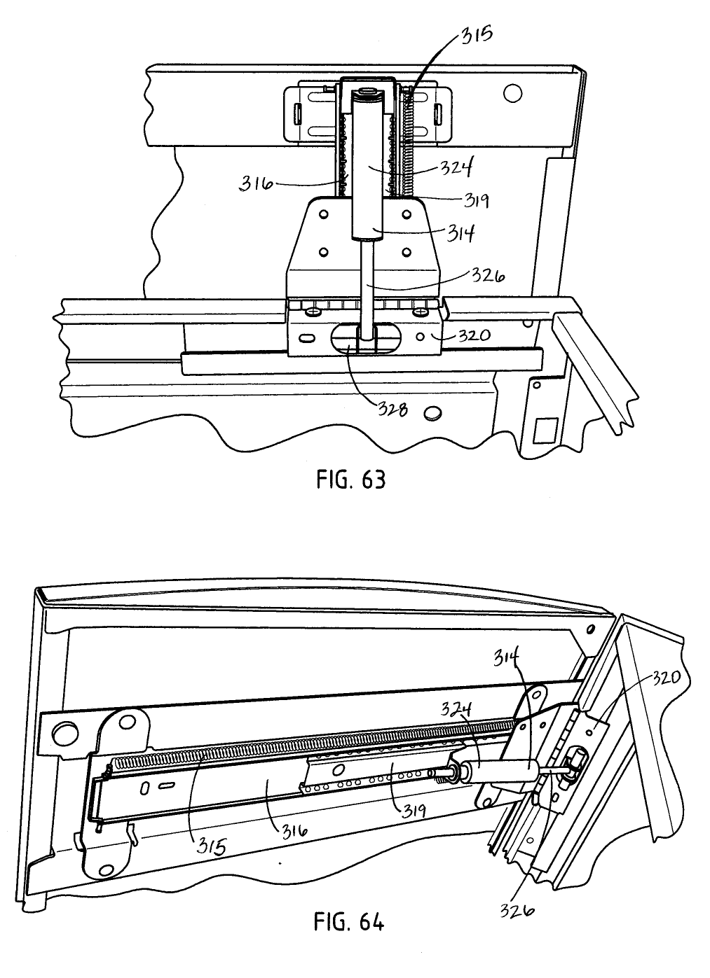

FIG. 62-64 illustrate over-the-case door 64′ at a nearly fully open position. The door 64′ is allowed to slide along slide 316 (or 318) until reaching the top of the slide at the inside top of the door. As shown in FIG. 64, slides 316 and 318 allow the over-the-case door 64′ to move downwardly relative to top panel 18 of storage unit assembly 10 until the bottom of the over-the-case door 64′ can abut bottom panel 20. Spring assist 315 lessens the rate of travel when the door 64′ is closed and minimizes the likelihood of injury to a user. In addition, when door 64′ is being opened, spring assist 315 assists door 64′ to open and come to rest above storage unit assembly 10.

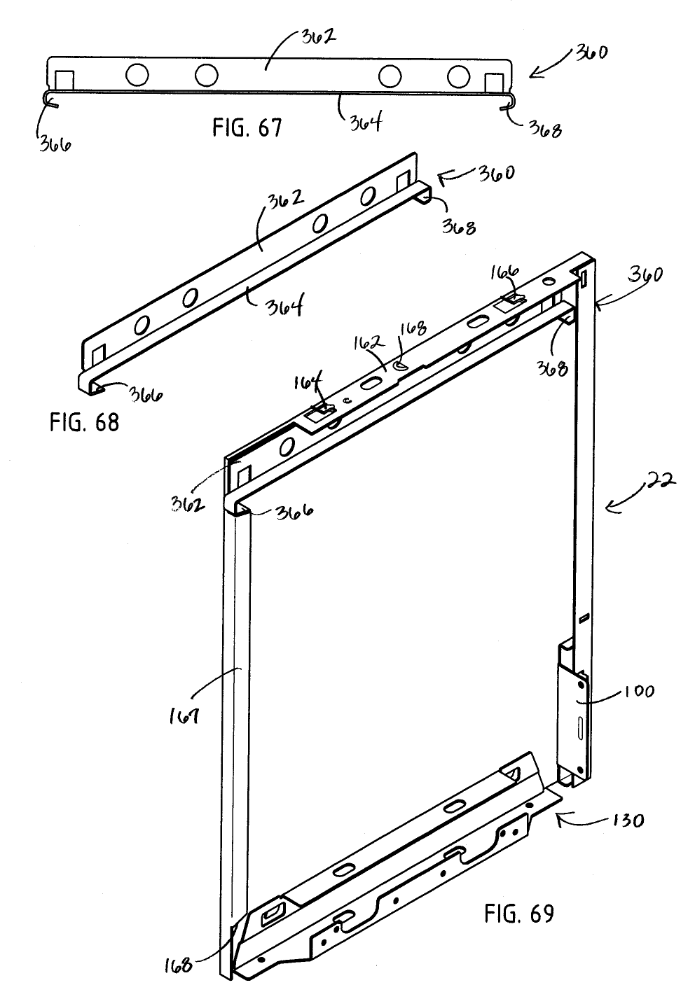

Referring now to FIGS. 65-71, a door 64″ having a substantially planar construction (such as the aforementioned wood door, metal door or picture frame door) may be used in an in-the-case construction or application. An in-the-case construction allows door 64″ to be in a closed position perpendicular with and below top panel 18 or an open position wherein in-the-case door 64″ is disposed parallel with top panel 18 and inside case 26. Door 64″ is adapted to slide in and out of case 26 in the in-the-case construction on guide rails 360 that are shown in FIGS. 67 and 68. The guide rails 360 are attached to first and second end panels 22, 24 and include a vertical portion 362 fixedly attached to the inside of first and second end panels 22, 24 as well as a rail portion 364 having forward and rearward hook-like stops 366, 368. As shown in FIG. 69, guide rail 360 is located at a top portion of the inside of first and second end panels 22, 24.

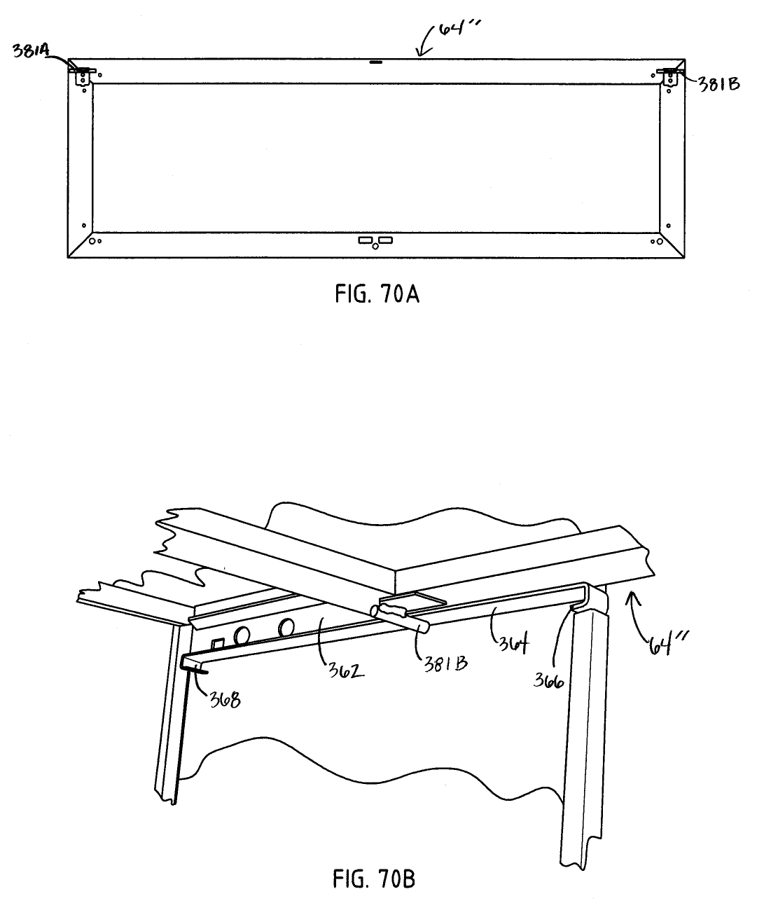

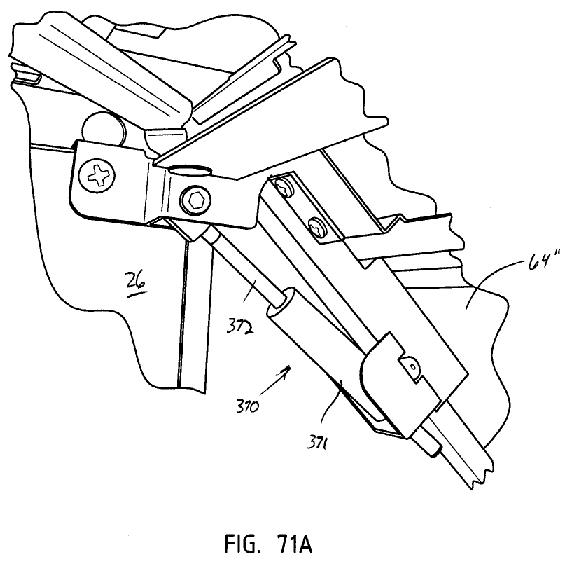

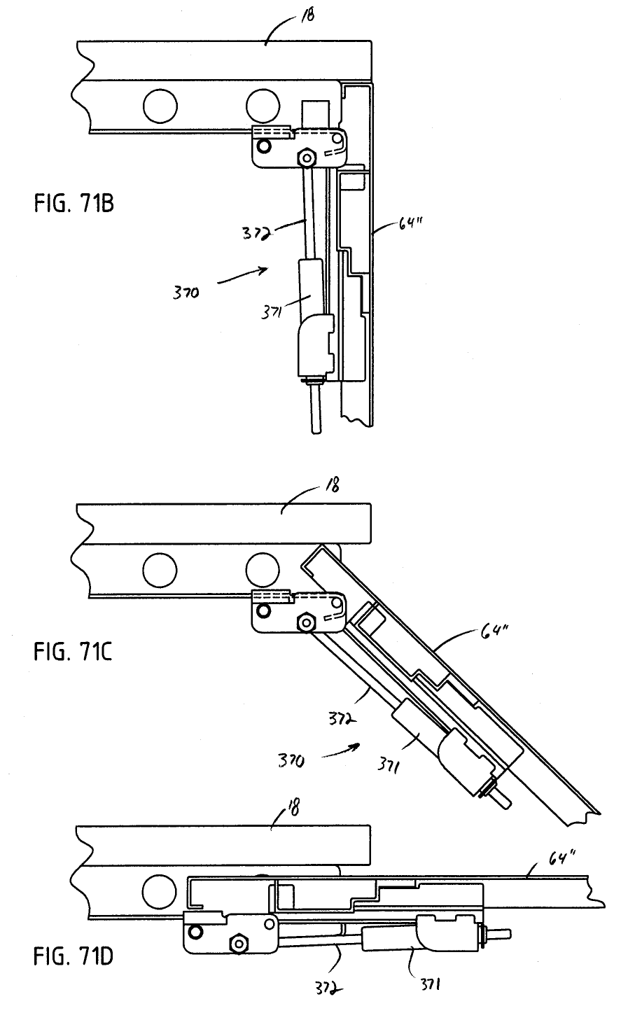

Referring to FIGS. 70 and 71, an in-the-case door support mechanism 361 includes in-the-case door 64″ attached to first and second pivot pins 381A, 381B located at an rear top portion of in-the-case door 64″. Each pivot pin 381A, 381B rests below guide rail 360 and is adapted to slide along the bottom of guide rail 360 between forward stop 366 (in a closed door position) and the rearward stop 368 (in an open door position). In the fully open position, in-the-case door 64″ rests on top of the guide rail 360. As mentioned above, the metal door 64A, wood door 64B, or picture frame door 64D may be used for an in-the-case application. As shown in FIGS. 71A-71D, a dampener mechanism 370 may be included that provides assistance to the user when the door is being closed. The dampener 370 includes a housing 371 pivotally attached to a top portion of a door 64″ and a rod 372 attached to an interior portion of case 26.

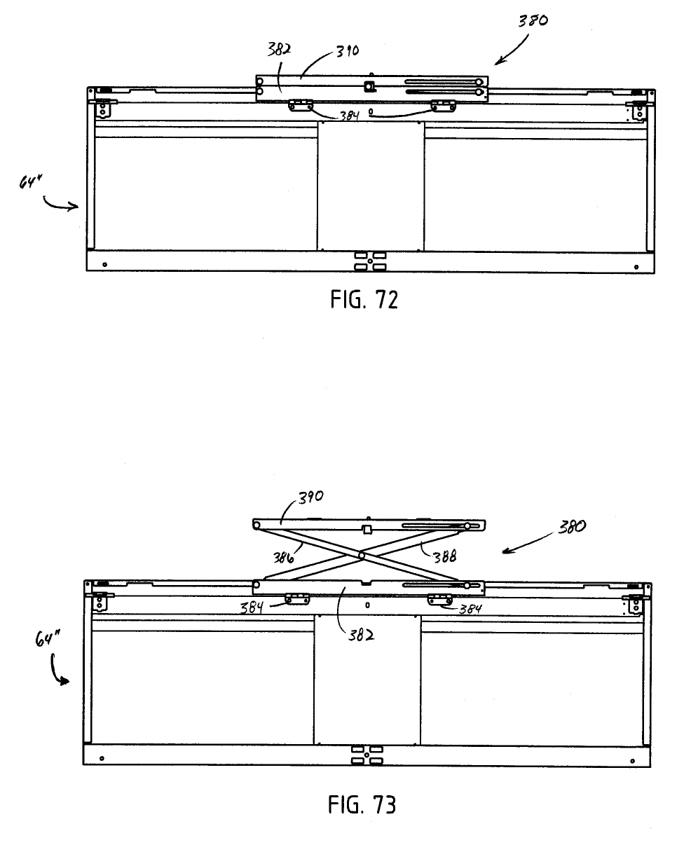

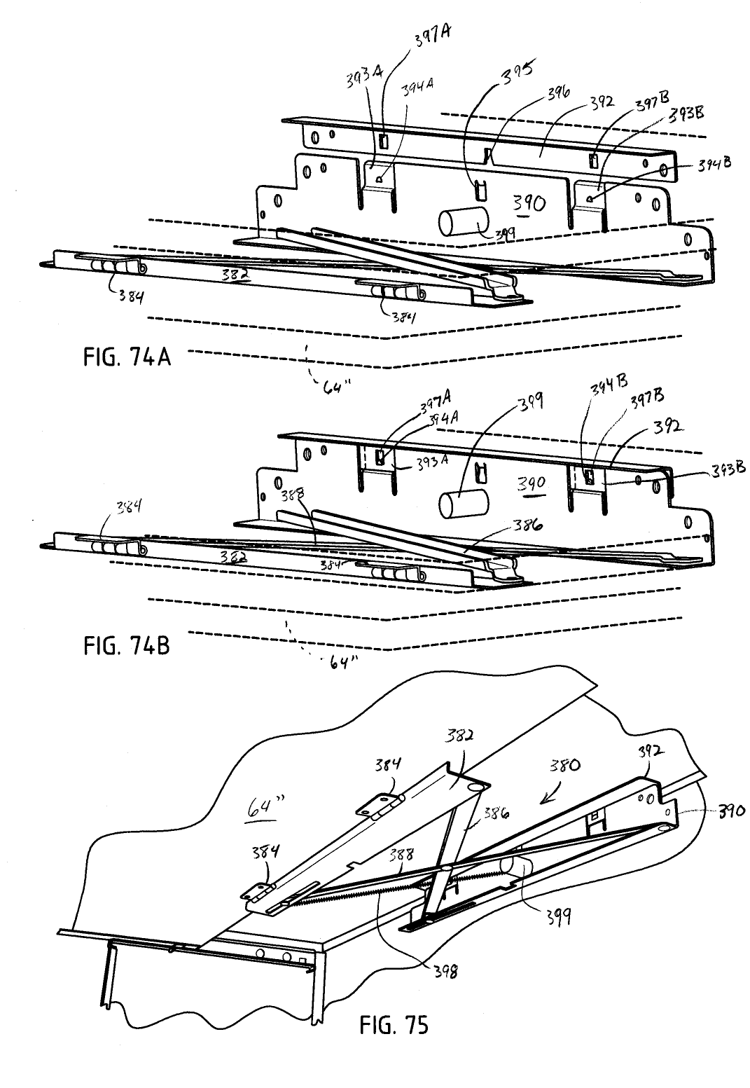

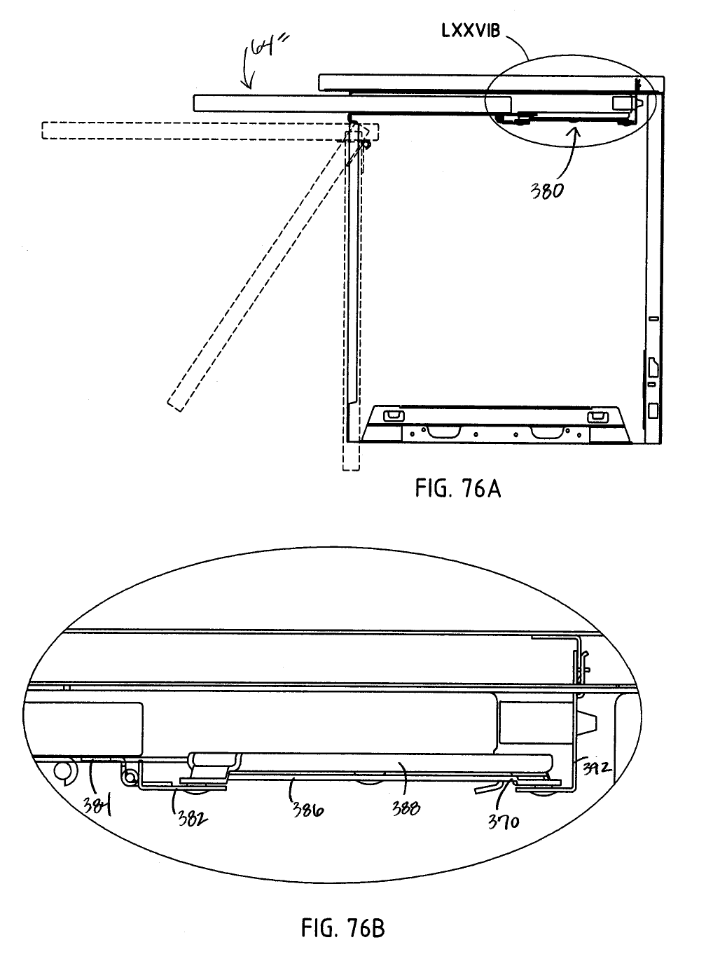

Referring now to FIGS. 72-75, an optional anti-racking mechanism 380 may be utilized that prevents in-the-case door 64″ from binding during opening or closing. Anti-racking mechanism 380 includes a door side bracket 382 attached to hinges 384 that are fixedly attached to a top portion of the rear of the in-the-case door 64″. Anti-racking mechanism 380 also includes first and second scissor members 386, 388 that cross and attach to a rear bracket 390. Rear bracket 390 releasably engages a quick connect bracket 392 (FIG. 75) which is fixedly attached to the underside of top panel 18 inside storage unit assembly 10. Rear bracket 390 includes tabs 393A and 393B with protuberances 394A and 394B, respectively, and a center tab 395 all of which laterally align and releasably attach rear bracket 390 with quick connect bracket 392. Rear bracket 390 includes center slot 396 and tab receiving apertures 397A and 397B which are adapted to receive protuberances 394A and 394B. Optionally, a spring assist 398 may be installed which is connected to the rear bracket 390 and door-side bracket 382.

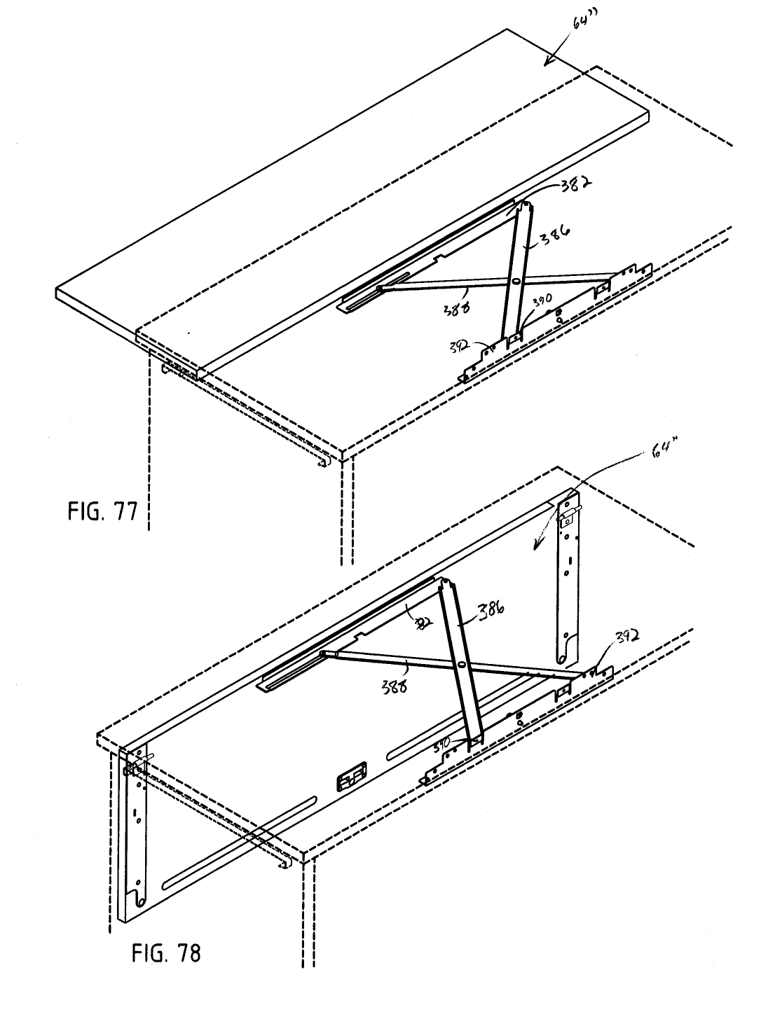

As shown in FIGS. 74A and 74B, to install anti-racking mechanism 380 the hinges are first fastened to the in-the-case door 64″. Rear bracket 390 is then lined up with quick connect bracket 392 such that tab receiving apertures 397A and 397B are aligned vertically with protuberances 394A and 394B (FIG. 74A). The rear bracket 390 is then lifted vertically. The center tab 395 engages and laterally aligns with the slot 396 while the rear bracket is lifted vertically until the protuberances 394A and 394B snappingly engage the receiving apertures 397A and 397B, holding rear bracket 390 in place. To remove rear bracket 390 from quick connect bracket 392, a prying tool, such as a screwdriver is used to separate the protuberances 394A, 394B from the receiving apertures 397A and 397B and the rear bracket is lowered out of position. Quick connect bracket 392 can be installed without the use of fasteners, allowing for easy and fast installation of the anti-racking mechanism 380. The hinges 384 attached to the front bracket 382 of the anti-racking mechanism 380 allow door 64″ to open and close while the anti-racking mechanism 380 maintains a substantially horizontal alignment, as shown in FIGS. 77 and 78. A bumper 399 may also be included which prevents the anti-racking mechanism and door from being slammed shut by a user.

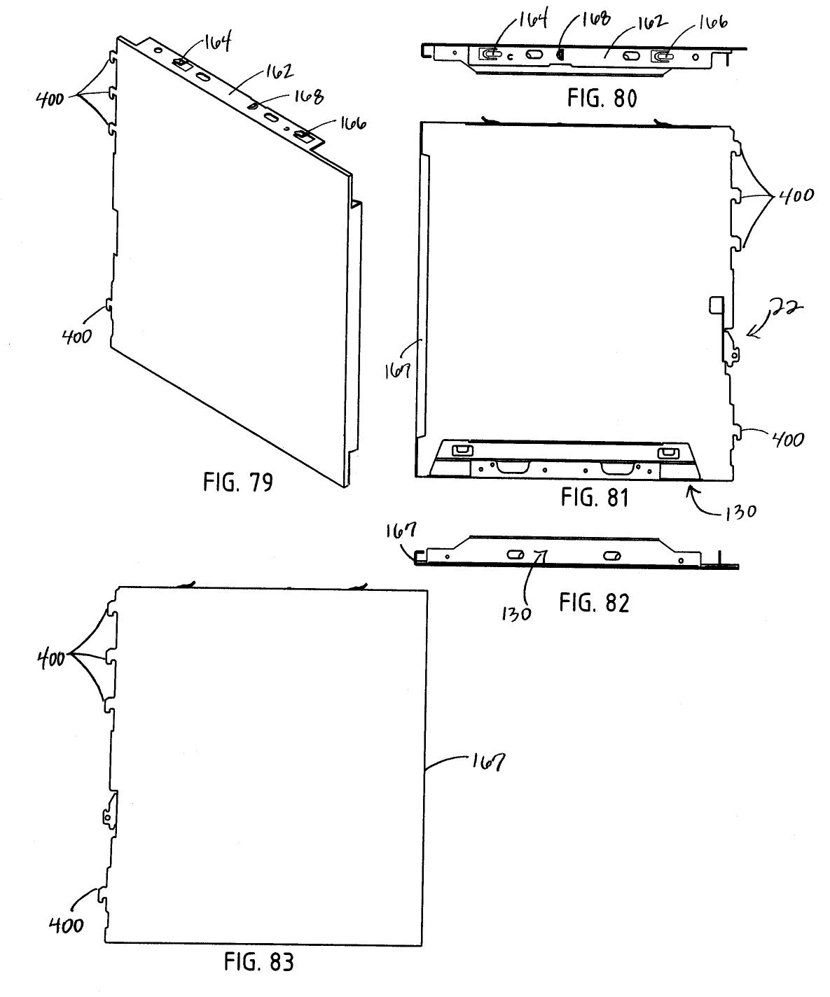

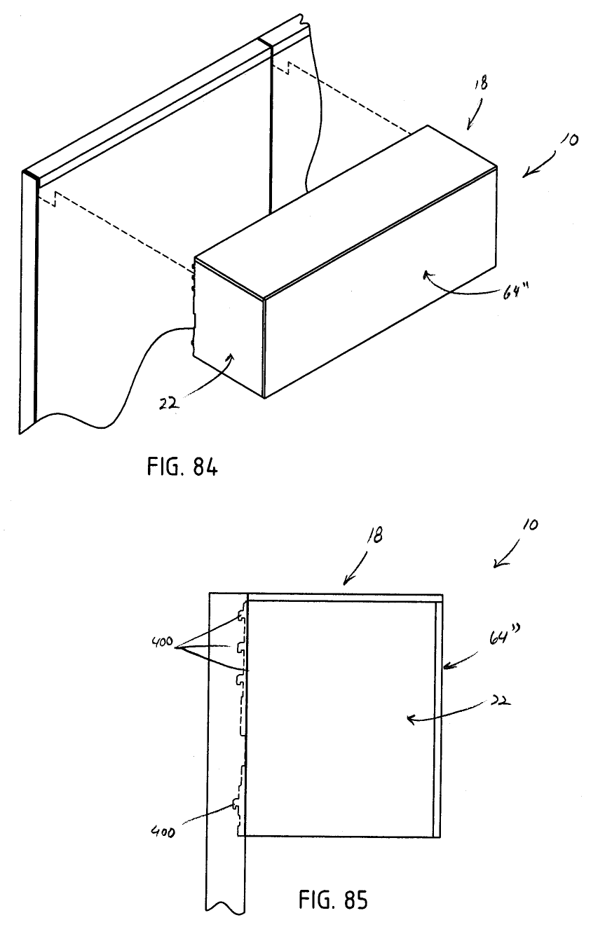

Referring now to FIGS. 79-83, end panel 22 (and also end panel 24) may include integral hooks 400 instead of or in addition to the slots 34 located at a rear portion 32 of first and second end panels 22, 24. As shown in FIGS. 84 and 85, when attached to top and bottom panels 18, 20, back stop rail 62 and bottom panel 20, the end panels 22, 24 act to support case 26 in a panel-hung condition.

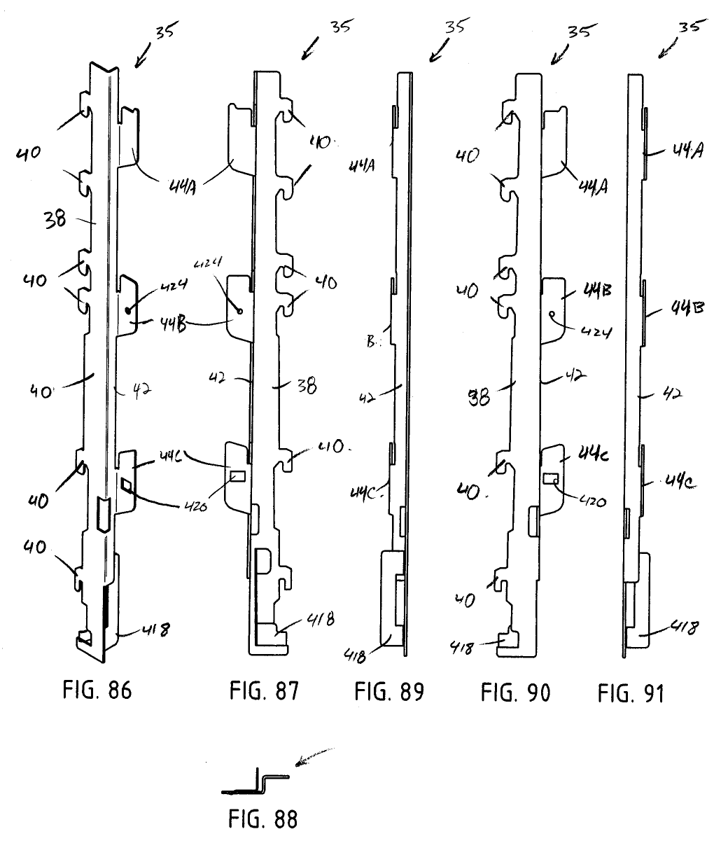

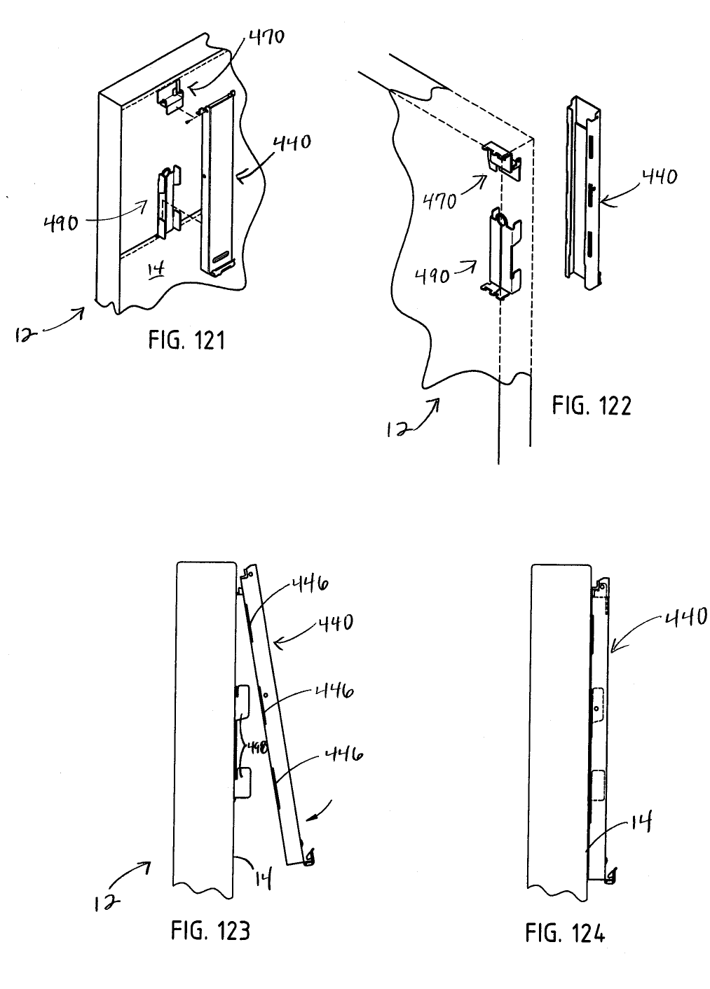

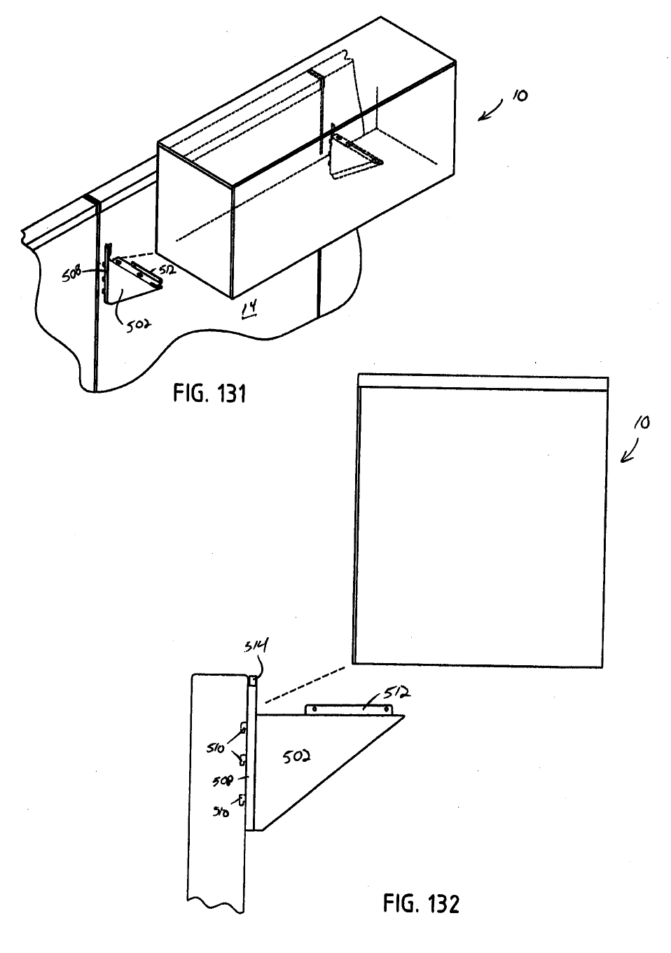

As shown in FIGS. 86-134, storage unit 10 may be installed on a panel or desk system in a variety of ways, as disclosed in further detail below and as disclosed in U.S. Provisional Application Ser. No. 60/940,879, filed May 30, 2007, entitled STORAGE UNIT ATTACHMENT ARRANGEMENT AND METHODS, which is hereby incorporated by reference.

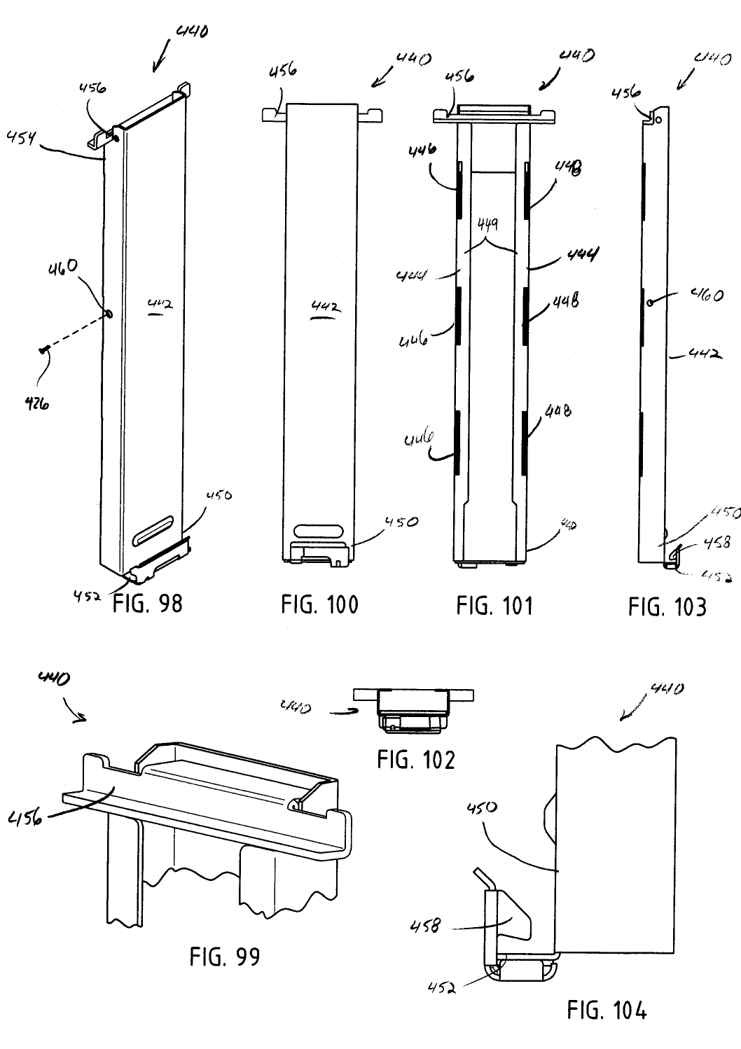

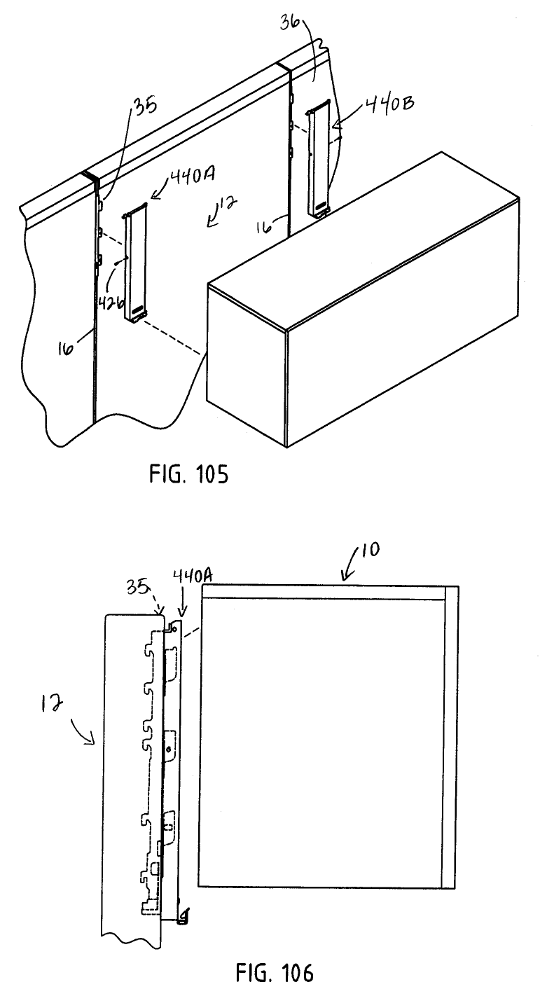

Referring now to FIGS. 86-91, for end panels 22, 24 having multiple slots 34 in the rear portion 32 of end panels 22, 24, hanger brackets 35, 36 are used to suspend case 26 in a panel hung condition. The first and second hanger brackets 35, 36 are mirror images of one another and have like components. The first hooks, or wall-side hooks 40 of the hanger bracket extend from a rear portion of the hanger bracket 35 and are shaped for reception in the slotted hangers 16 in an office furniture unit 12. Second hooks, or case-side hooks 44A, 44B, 44C (collectively referred to as 44) are shaped for reception in the slots 34 in the rear portions 32 of the first and second end panels 22, 24 and support the case 26 when installed in the panel-hung condition against the outer face 46 of office furniture unit 12. Hanger brackets 35, 36 may include an anti-dislodgement clip 418 designed to engage a slotted hanger 16 in office furniture unit 12 and prevent the hanger brackets 35, 36 as well as case 26 from being accidentally removed. It should be understood that any number or configuration of first hooks 40 may be present on the hanger brackets 35, 36 so that the hanger brackets 35, 36 can interface properly with the relevant slotted hanger in the associated furniture unit 12. The lowermost case-side hook 44C includes an anti-dislodgement aperture 420 for receiving an anti-dislodgement clip 422, as will be discussed in greater detail below. Also, the middle case-side hook 44B includes an anti-dislodgement aperture 424 for receiving an anti-dislodgement pin 426 (FIGS. 98 and 105) in a vertical off-module arrangement.

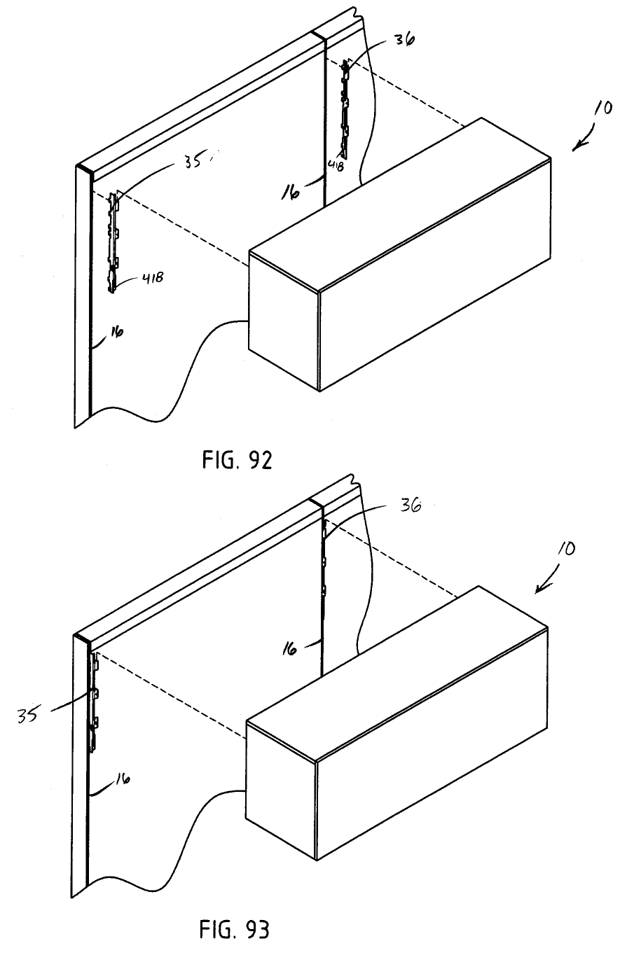

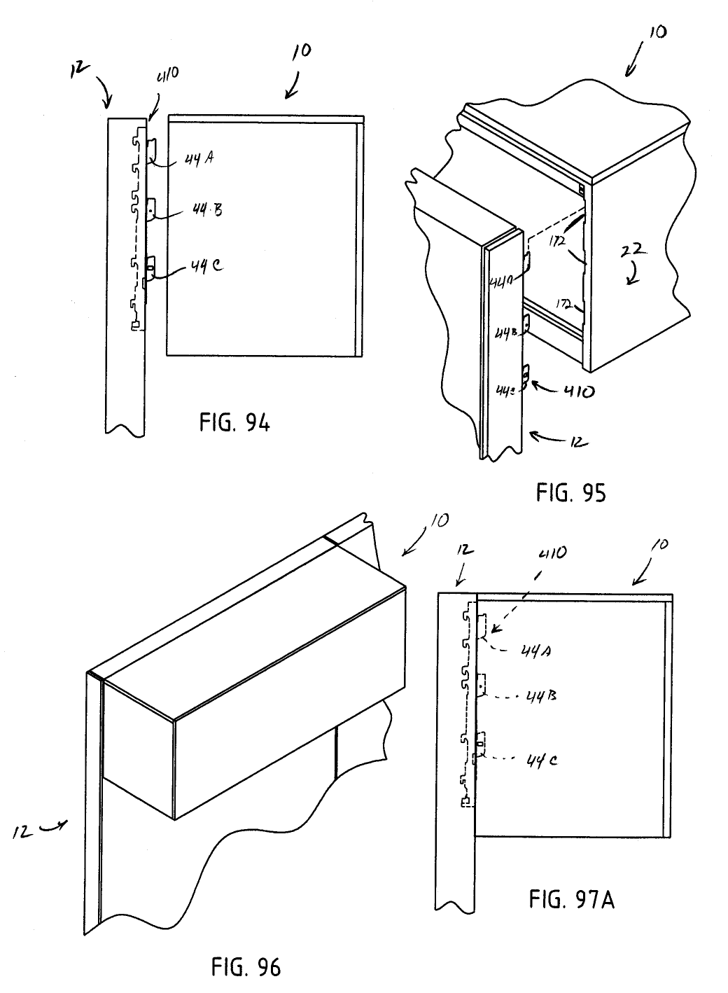

Referring now to FIG. 92, during installation of storage unit assembly 10 to office furniture unit 12, first and second hanger brackets 35 and 36 are first inserted into the slotted hangers 16 in office furniture unit 12. If an anti-dislodgement clip 418 is present, the same is properly inserted into a slotted hanger 16 to prevent dislodgement of the hanger bracket 35 after installation. After the hanger brackets 35 and 36 have been installed, the storage unit 10 is lined up vertically and horizontally (FIGS. 94 and 95) so that the case-side hooks 44A, 44B, 44C are directly behind the slots 34 in the first and second end panels 22, 24. First and second end panels 22, 24 are then inserted onto the case-side hooks 44A, 44B, 44C and storage unit assembly 10 is allowed to lower onto the hooks 44A, 44B, 44C (FIGS. 96 and 97A).

Referring now to FIGS. 97B and 97C, the anti-dislodgement clips 420 on end panels 22, 24 are designed to engage anti-dislodgement aperture 420 of hanger brackets 35, 36 through an aperture 422 in the rear portion 32 of the end panel 22. During installation, the anti-dislodgement clips 430 are simply pulled back against the spring force of the clip 430 and allowed to spring back into aperture 422 and consequently anti-dislodgement aperture 420 when case-side hook 44C of hanger bracket 35 has been fully inserted into bottom slot 34 in the rear portion 32 of end panel 22, as illustrated in FIG. 97C. The same is done with respect to end panel 24 and hanger bracket 36. The anti-dislodgement clips 430 prevent end panels 22, 24 from becoming accidentally dislodged from the hanger brackets 35, 36.

In many instances, a storage unit assembly 10 must be installed in an off-module arrangement. In these situations, a bracket that translates the binder bin from an on-module position to an off-module position is necessary.

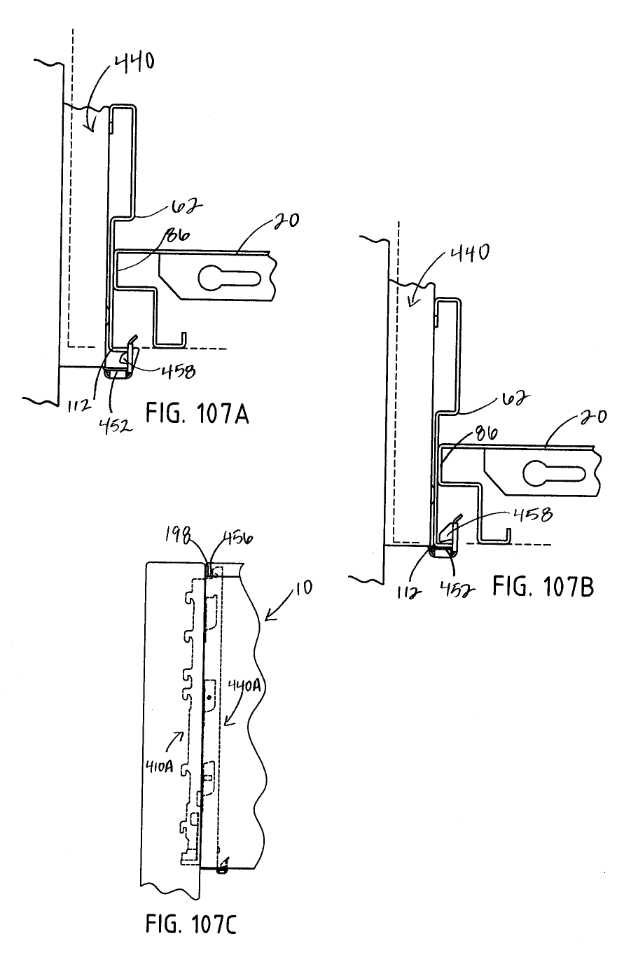

FIGS. 98-104 illustrate a vertical off-module support bracket 440. The vertical off-module bracket 440 includes a substantially planar front portion 442 and a rear portion 444 that has two sets of vertically-oriented slots 446, 448 that extend through inwardly extending flanges 449. The two sets of vertically-oriented slots 446, 448 allow the vertical off-module bracket 440 to be used on either side of storage unit assembly 10. The slots 446, 448 receive the case-side hooks 44 of the first and second hanger brackets 35, 36 when storage unit assembly 10 is placed in a vertical off-module panel-hung condition. A forward bottom portion 450 includes a lower support ledge 452 adapted to support the base flange of back stop rail 62 when storage unit assembly 10 is placed in a vertical off-module panel hung condition (FIG. 107B). A forward top portion 454 of the vertical off-module support bracket 440 includes a forward top ledge 456 adapted to provide lateral support to storage unit assembly 10 to prevent the same from rotating off of the lower support ledge 452. A fastener aperture 457 is located in forward top portion 454 on each side of vertical off module bracket 440. Case 26 is hung on the vertical off-module support bracket 440 in a manner which permits case 26 to shift laterally relative to first and second hanger brackets 35, 36. An anti-dislodgement clip 458 is mounted on the forward bottom portion 450 of the vertical off-module support bracket 440 and prevents accidental dislodgement of back stop rail 62 from the lower support ledge 452. Further, an anti-dislodgment aperture 460 in the vertical off-module bracket 440 is designed to receive a pin that also penetrates the anti-dislodgement aperture 424 in the hanger bracket 35, thus preventing the vertical off-module support bracket 440 from being disengaged from the hanger bracket 35.

Referring now to FIGS. 105-107, during installation of storage unit assembly 10 into a vertical off-module condition, first and second hanger brackets 35, 36 are inserted into the slotted hangers 16 in office furniture unit 12. One of the sets of vertically-oriented slots 446, 448 in the rear portion 444 of first and second vertical off-module brackets 440A and 440B are lined up and inserted over the case-side hooks 44A, 44B, 44C of the hanger brackets 35, 36, respectively. The vertical off-module brackets 440A and 440B are allowed to hang from the hanger brackets 35 and 36 and storage unit assembly 10 is rested on the lower support ledge 452 of each vertical off-module bracket 440A, 440B. As the base flange 112 of back stop rail 62 comes to rest against the lower support ledge 452, the forward top ledge 456 abuts the inwardly extending rear flange 198 of the top panel 18. The anti-dislodgement clip 458 of each vertical off-module bracket 440A, 440B snaps over the base flange 112 of back stop rail 62 as storage unit assembly 10 is lowered into place, as shown in FIG. 107B.

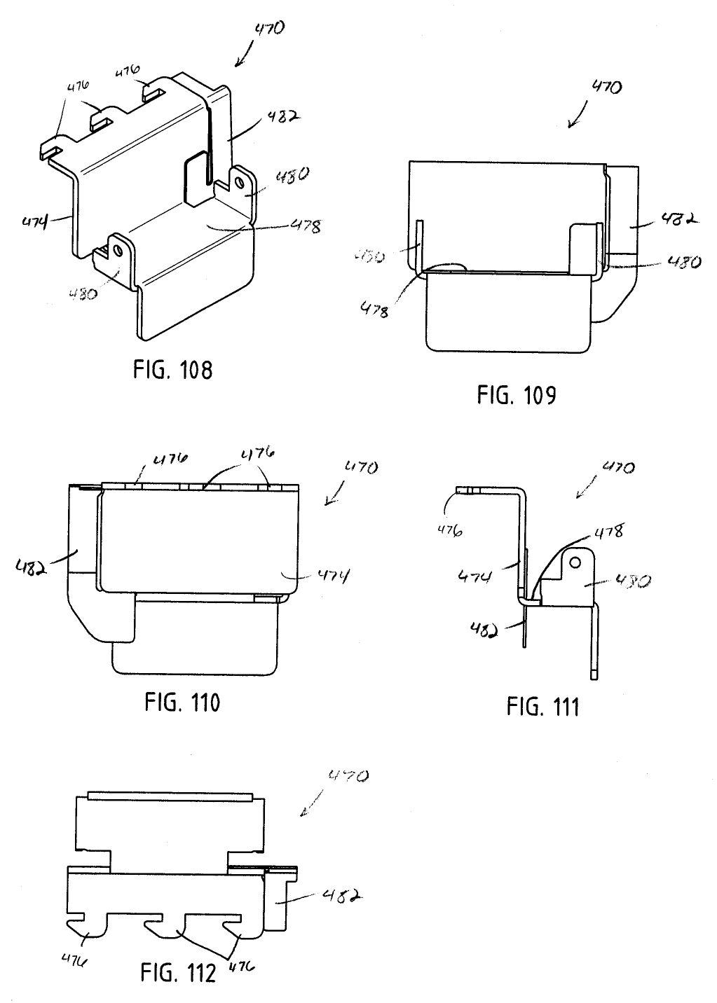

FIGS. 108-112 illustrate a top bracket 470 of a horizontal off-module support bracket system 472. The top bracket 470 includes a rear portion 474 with horizontal hooks 476 shaped for reception in horizontal slotted hangers 16 on an associated office furniture unit. A forward top portion 478 has upwardly extending flanges 480 that selectively engage the rear flanges 449 of the vertical off-module support bracket 440. Upwardly extending flanges 480 include fastener apertures that, after installation, align with fastener apertures 457 of vertical off-module bracket 440. The top bracket 470 also includes an anti-dislodgement clip 482.

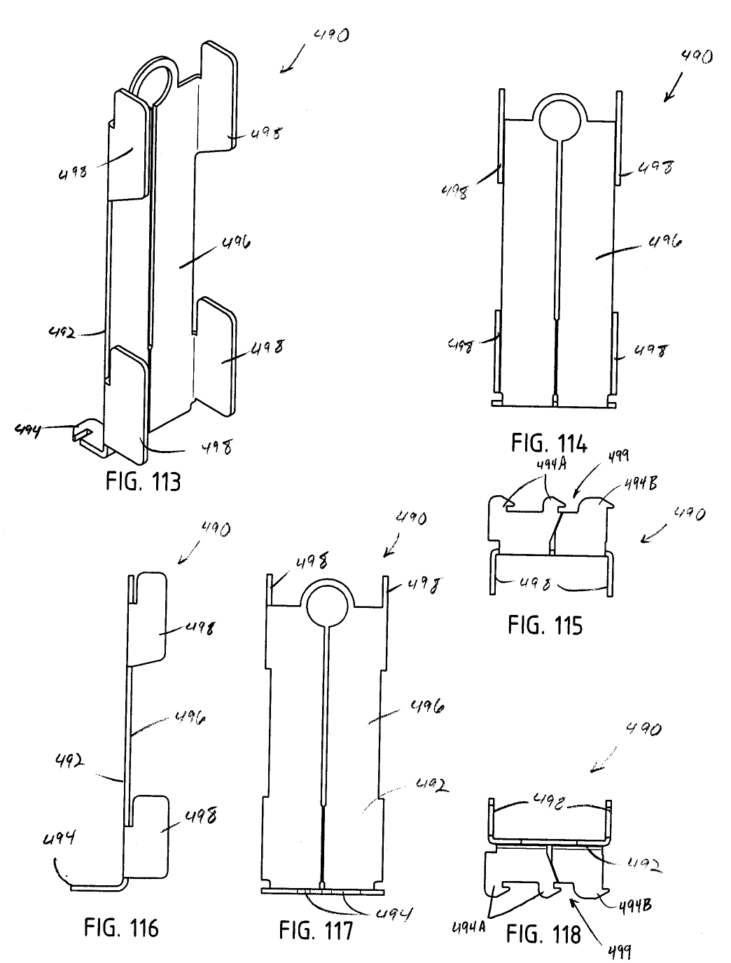

FIGS. 113-118 show a bottom bracket 490 of the horizontal off-module support bracket system 472. The bottom bracket 490 has side portions 491A and 491B, a rear portion 492 with two small horizontal hooks 494A and a large horizontal hook 494B shaped for reception in horizontal slotted hangers 16 in office furniture unit 12. A forward portion 496 of the bottom bracket 490 includes vertical hooks 498 that can be selectively received in the lowermost of slots 446, 448 in the rear portion 444 of the vertical off-module bracket 440 to detachably support storage unit assembly 10 in a panel-hung condition against the outer face of office furniture unit 12. As shown in FIG. 120A, an anti-dislodgement feature 499 includes a spring joint 500 that connects the side portions 491A and 491B which are spring biased away from one another. Anti-dislodgement feature 499 prevents bottom bracket 490 from being dislodged from the horizontal slotted hangers 16 accidentally, as will be explained in further detail below.

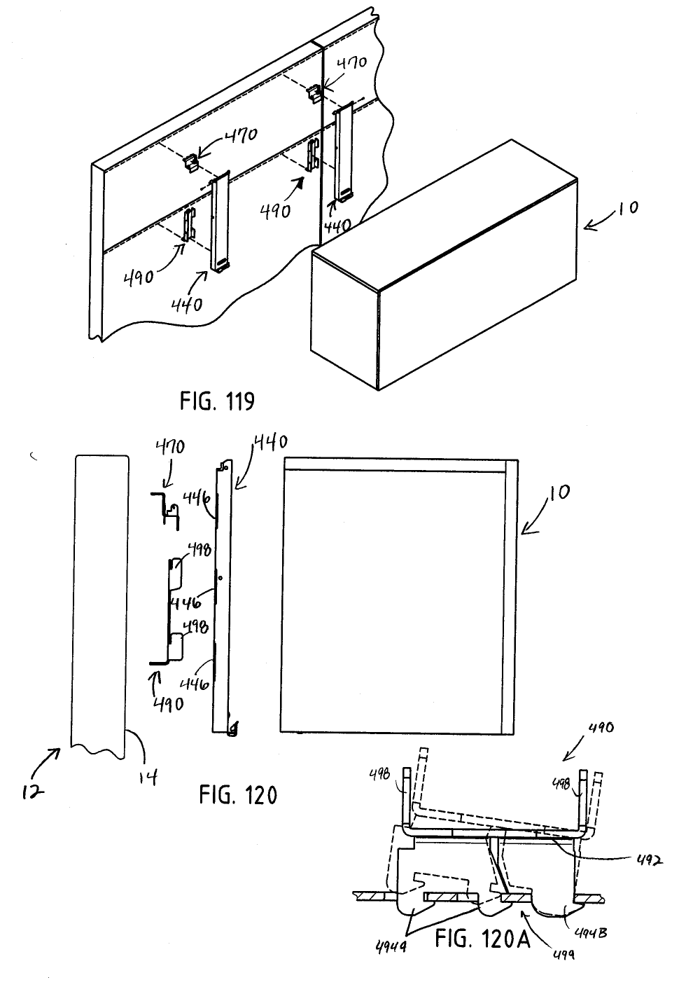

Referring to FIGS. 119-126, during installation, the horizontal off-module bracket system 472, including the top and bottom brackets 470, 490, are first inserted into horizontal slotted hangers 16 in office furniture unit 12 with the top bracket 470 in position directly above bottom bracket 490. Large horizontal hook 494B is first inserted into one of the horizontal slotted hangers and side portions 491A and 491B are pushed toward one another to allow small horizontal hooks 494A to engage slots in slotted hanger 16. Bottom bracket 490 is then rotated laterally until small horizontal hooks 494A are received in adjacent slots in horizontal slotted hanger 16. Large horizontal hook 494B fills an entire slot, while small horizontal hooks 494A do not.

Referring again to FIGS. 119-126, the vertical off-module support bracket 440 is then inserted into the top bracket 470 with the inwardly extending rear flanges 449 sliding behind the upwardly extending flanges 480 of the top bracket 470 of the horizontal off-module bracket system 472, as shown in FIG. 123. The middle and lowermost of the slots 446, 448 of the vertical off-module brackets 440 are then aligned with the vertical hooks 498 of the bottom bracket 490 and inserted thereon. After vertical off-module support bracket 440 is inserted onto bottom bracket 490, bottom bracket 490 cannot be separated from horizontal slotted hanger 16. The vertical off-module bracket 440 prevents spreading of the side portions 491A and 491B from one another and consequently, bottom bracket cannot be removed from slotted hanger 16 while vertical off-module bracket 440 is connected therewith. A mechanical fastener may be secured through an aperture to secure top bracket 470 to vertical off-module bracket 440.

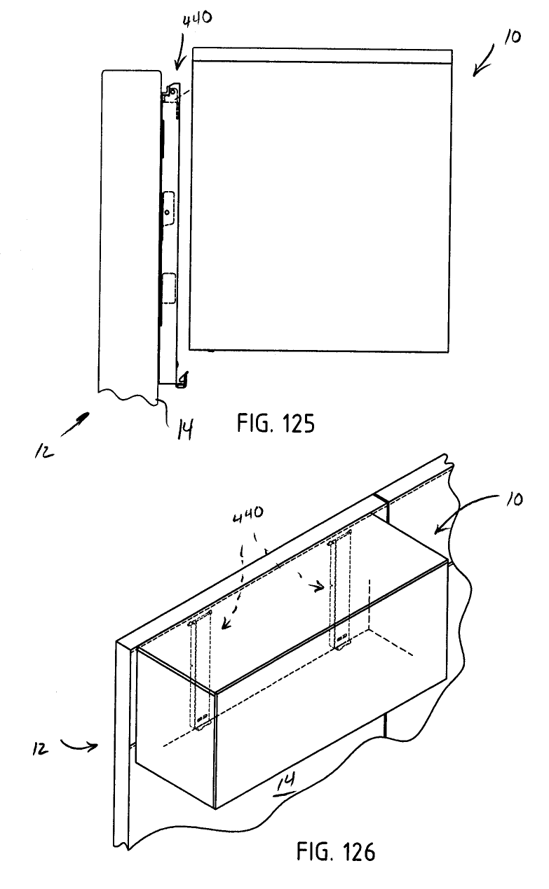

As shown in FIGS. 125 and 126, storage unit assembly 10 is now ready to be installed on the vertical off-module bracket 440 similarly to the manner of installation disclosed with respect to FIGS. 105-107 above.

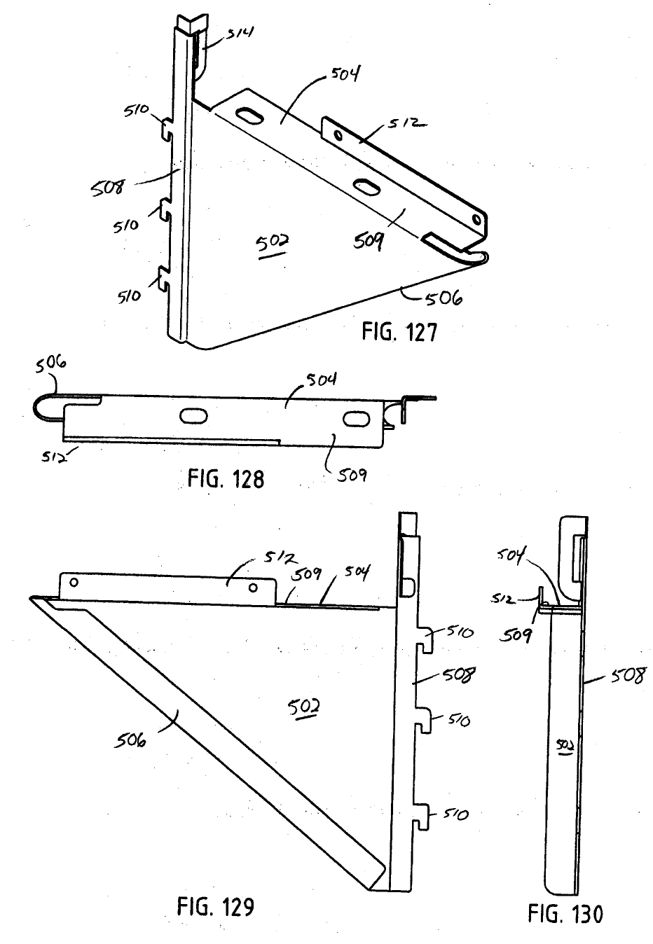

Alternatively, storage unit assembly 10 may be installed in an up-mounted condition. To install storage unit assembly 10 in an up-mounted condition, up-mount brackets are necessary. As shown in FIGS. 127-130, up-mount bracket 48 has a lower portion 502 shaped for connection with an associated one of office furniture unit 12, and an upper portion 504 adapted to connect with and support the connector brackets at the bottom of case 26 to detachably mount case 26 in an up-mounted condition above the top of a furniture unit. The lower portion of up-mount bracket 48 includes a triangular shape with a lower arcuate flange 506 and a hook portion 508. The hook portion 508 includes a plurality of hooks 510 adapted to engage slotted hangers 16 in office furniture unit 12. The lower arcuate flange 506 can be used to route electrical/communication wires and the arcuate construction minimizes the likelihood of injury to a user that may accidentally contact up-mount bracket 48. The upper portion 504 includes a top horizontal support flange 509 and a top vertical support flange 512. An anti-dislodgement clip 514 may be present on the hook portion 508 to prevent up-mount bracket 48 from being accidentally dislodged.

To install storage unit assembly 10, the hook portion 508 of two up-mount brackets 48 is first installed into the slotted hangers 16 in office furniture unit 12. Connector brackets 98, described above with reference to FIGS. 15-19, of storage unit assembly 10 are then placed on the horizontal support flanges 509 of the up-mount brackets 48 and fastened thereto as shown in FIGS. 133A and 134. Alternatively, storage unit assembly 10 may be installed in an up-mounted condition on a desk/service module assembly 511 as shown in FIG. 133B.

As shown in FIGS. 135-139, a lock assembly 520 includes a lock housing 76 with spring tabs 524 adapted to engage bottom panel socket 74 shown in FIGS. 5 and 8 and located on the underside of bottom panel 20. The lock housing 76 covers the lock assembly 520 and lock arm 92 designed to engage lock apertures 236, 238 in a door 64A, 64B, 64C, or 64D, thereby locking storage unit assembly 10 when not in use.

Referring to FIGS. 135-139, during installation, the lock housing 76 is installed beneath bottom panel 20. The lock housing 76 is inserted so that a key hole 523 extends downwardly through a lock cylinder aperture 530 (FIG. 138) that extends downwardly. During installation, the spring tabs 524 are in abutting contact with the underside of bottom panel 20. As the lock housing 76 is forced into position, spring tabs 524 flex inwardly until the lock assembly 520 projects through the lock cylinder aperture 530 that extends through socket flange 84, at which time spring tabs 524 force lock housing 76 downward and frictionally secure lock housing 76 inside the socket 74.

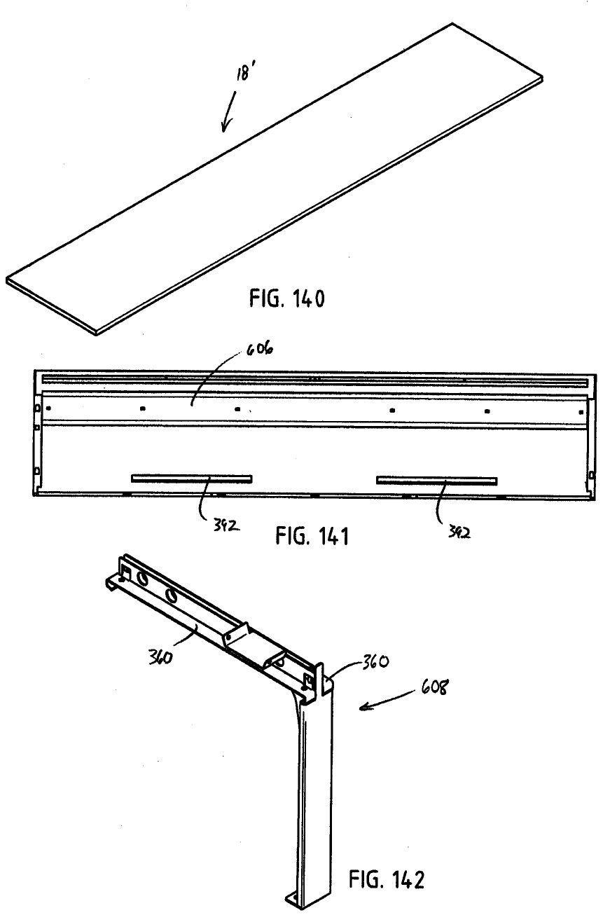

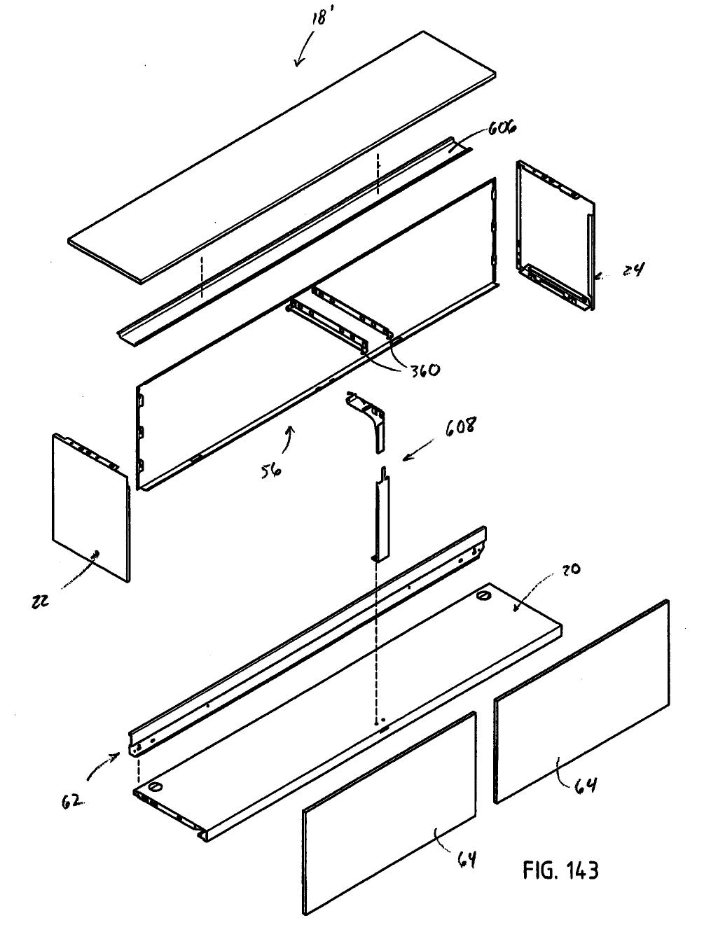

Referring to FIGS. 140-143, in a dual door assembly 600, a top panel 18′ having four cutouts 604 for hinge mechanisms of two doors 64A′, 64B′, 64C′, or 64D′ is used. The underside of the top panel 18′ includes two quick connect brackets 392 for two anti-racking mechanisms 380. In addition, to supply structural rigidity, a hat channel 606 is secured to the underside of the top panel 18′. FIG. 142 shows a dual door support 608 including multiple guide rails 360 that is used to provide guides for in-the-case constructions. Specifically, the dual door support 608 includes two guide rails 360 connected by a bracket assembly 610 that supports the guide rails 360 adjacent to the underside of top panel 18′. FIG. 143 illustrates the dual door assembly 600 which is similar to the single door construction except it includes two doors 64 and the dual door support 608 as well as the modified top panel 18′ with additional cutouts 604 for hinge mechanisms and reinforcing hat channel 606. Note that the cutouts 604 for the hinge mechanisms may not be present in a dual door in-the-case application.

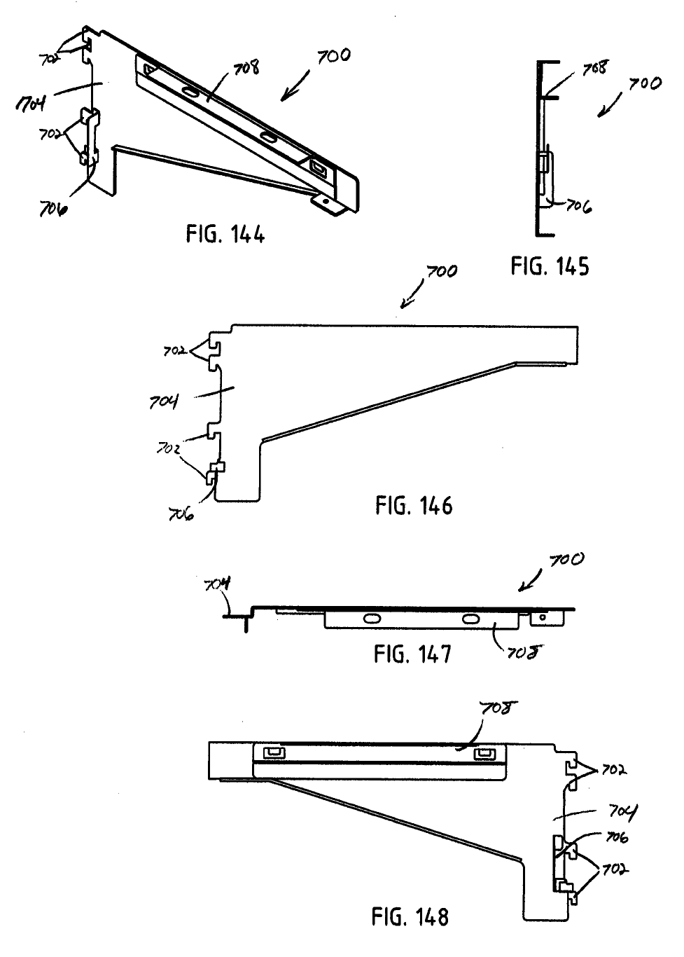

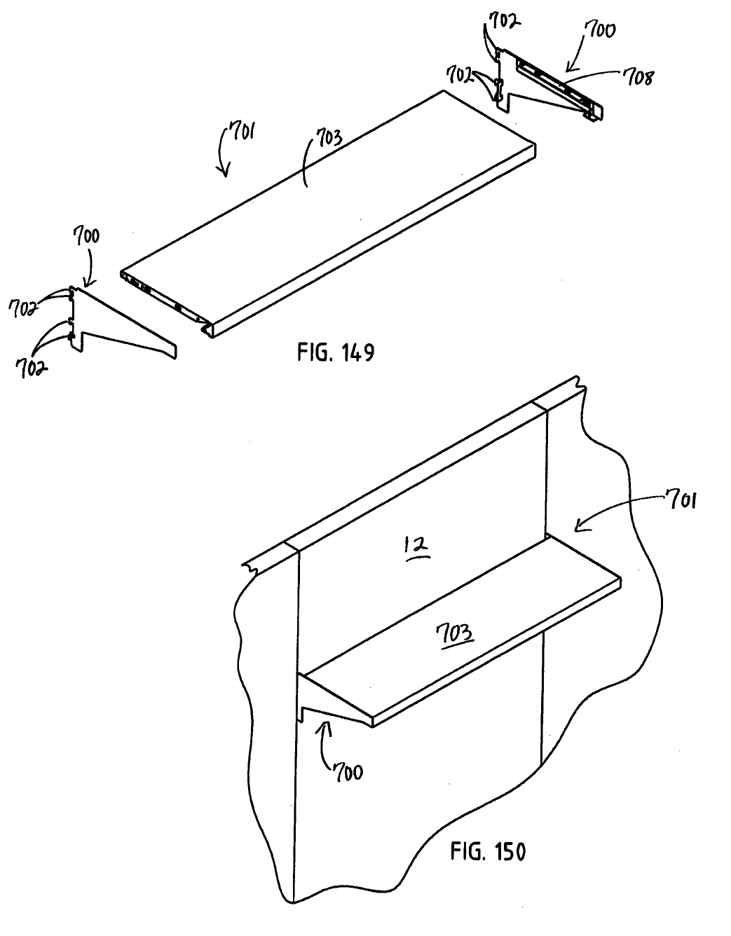

Referring now to FIGS. 149-150, a shelf assembly 701 having no side walls and integral shelving brackets 700 may be supplied to complement the office furniture system. A shelf 703 is included and is substantially similar to the bottom panel 20 but does not include a lock aperture 90. Shelf brackets (shown in FIGS. 144-148) are included and have integral hooks 702 connected at a rearward end 704 of the shelf bracket and also include an anti-dislodgement clip 706. Shelf brackets 700 also include a connector bracket 708 that connects the shelf bracket 700 with the shelf 703. As shown in FIG. 150, the shelf assembly 701 does not include a back stop rail nor side walls.

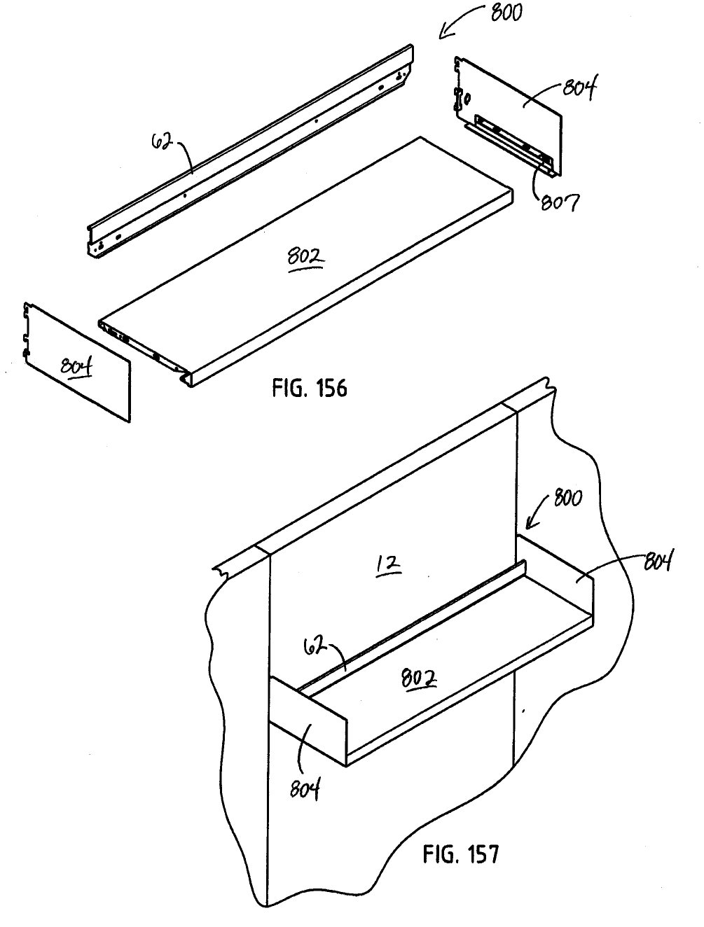

Referring now to FIGS. 156-157, a second shelf assembly 800 having a shelf 802 with end walls 804 may be used to complement an office furniture setting. The shelf 802 engages connector brackets 807 on the end walls 804. The second shelf assembly 800 also includes a back stop rail 62 and anti-dislodgement clips 806. Back stop rail 62 engages rail brackets 808 attached to the shelf brackets 802.

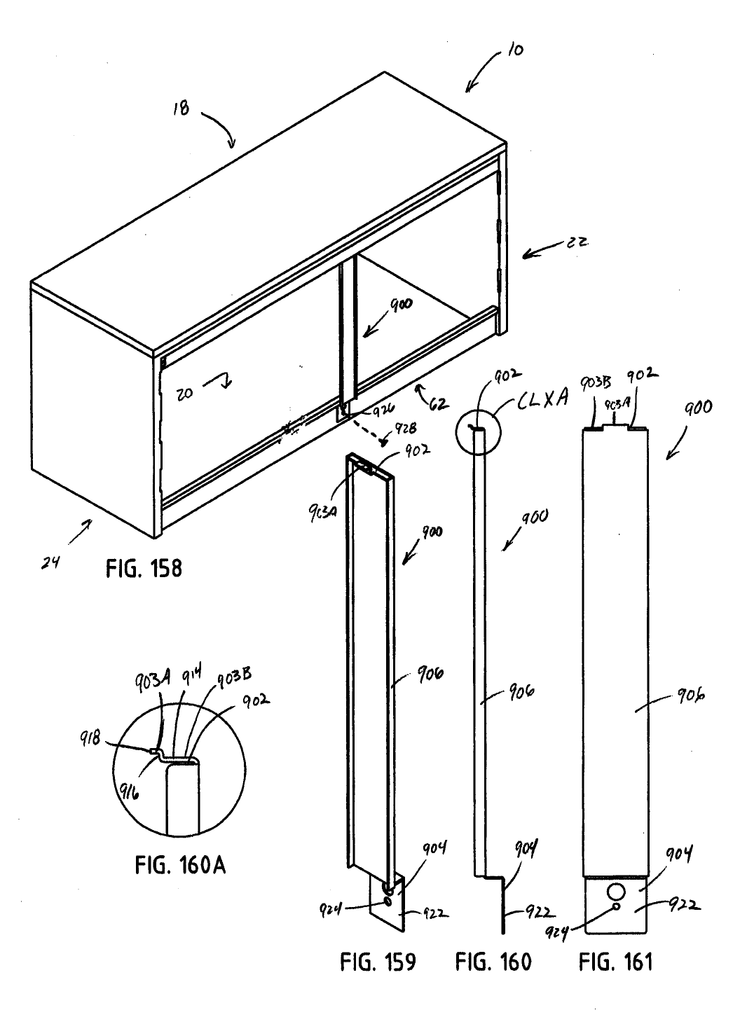

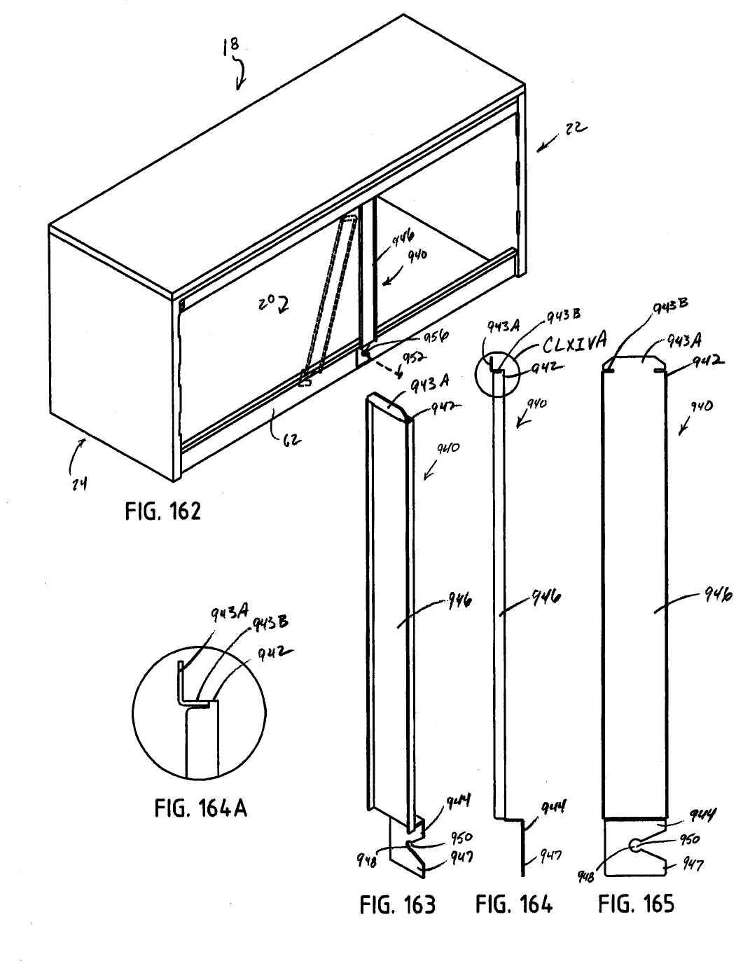

Referring now to FIGS. 158-161, for a dual door assembly, a support strut 900 is supplied to add structural integrity to case 26 and may be permanently fastened to the rear of storage unit assembly 10. The support strut 900 includes a top engagement portion 902 with a top tab 903A and an abutment portion 903B, a bottom engagement portion 904, and an elongate body 906. Top tab 903A includes a horizontal extension 914, a vertical extension 916 and a horizontally extending distal end 918 that engages a strut aperture 920 (FIG. 32) in the inwardly extending rear flange 198 below top panel 18. The horizontally extending distal end of top tab 903A is inserted into the strut aperture 920 and the inwardly extending rear flange 198 rests on the abutment portion 903B. The bottom engagement portion 904 includes a flat downwardly extending flange 922 offset from the elongate body 906. A fastener aperture 924 that extends through the bottom engagement portion 904 receives a mechanical fastener 928 secured in a receiving aperture 926 in back stop rail 62.

FIGS. 162-165 illustrate a support strut 940 may be used for transporting storage unit assembly 10. The support strut 940 includes a top engagement portion 942 with a cam surface 943A, and an abutment portion 943B, a bottom engagement portion 944, and an elongate body 946. Cam surface 943A is rotated into place which results in cam surface 943A being inserted into a strut aperture 920 (FIG. 32) and the inwardly extending rear flange 198 of case 26 rests on the abutment portion 943B. The bottom engagement portion 944 includes a flat downwardly extending flange 947 offset from the elongate body 946. A fastener receiver 948 having an open portion 950 receives a mechanical fastener 952 secured in a receiving aperture 956 in back stop rail 62.

A method for making a storage unit assembly for office furniture units of the type having a like construction with slotted hangers extending along outer faces thereof includes forming bottom panel 20 to abuttingly support objects thereon. Top panel 18 is formed in a shape to cover at least a portion of bottom panel 20. Top panel 18 is positioned in a generally parallel, spaced apart relationship with bottom panel 20. First and second end panels 22, 24 are formed with rear portions 32 having a plurality of vertically spaced slots 34 therein. First and second end panels 22, 24 are positioned at opposite ends of top and bottom panels 18, 20 and are interconnected to define rigid, box-shaped case 26 having generally rigid bottom portion 28 and generally open back portion 30. First and second hanger brackets 35, 36 are formed, each having rear portion 38 with first hooks 40 shaped for reception in the slotted hangers 16 of a first selected one of the office furniture units 12, and a forward portion 42 with second hooks 44 shaped for reception in the slots 34 in rear portions 32 of first and second end panels 22, 24. First hooks 40 on first and second hanger brackets 35, 36 are inserted into the slotted hangers 16 on the first selected furniture unit. Second hooks 44 on the first and second hanger brackets 35, 36 are inserted into slots 34 in rear portions 32 of first and second end panels 22, 24 to detachably support case 26 in a panel-hung condition against the outer face 14 of the first selected office furniture unit. An up-mount bracket 48 is formed with a lower portion 52 shaped for connection with a second selected one of the office furniture units, and an upper portion 54 shaped for connection with the bottom portion 28 of case 26. Lower portion 52 of the up-mount bracket 48 is mounted with the second selected furniture unit. The upper portion 54 of the up-mount bracket 48 is connected with bottom portion 28 of case 26 to detachably mount case 26 in an up-mounted condition above a top portion 54 of the second selected furniture unit. A removable back panel 56 is formed in a shape to enclose at least a portion of the open back portion 30 of case 26, and has side portions 58 with outwardly protruding hooks 60 shaped for reception in slots 34 in rear portions 32 of first and second end panels 22, 24. Hooks 60 on the back panel 56 are inserted into slots 34 in rear portions 32 of first and second end panels 22, 24 to detachably connect back panel 56 with case 26 and enclose at least that portion of the open back portion 30 of case 26 disposed above top portion 54 of the second selected office furniture unit when the case is in the up-mounted condition.

An anti-dislodgement clip 430 can be mounted on the case 26 adjacent to one of the first and second end panels 22, 24. The second hooks 44 on said first hanger bracket 35 are engaged in the panel-hung condition, and the hooks 60 on the back panel 56 are engaged in the up-mounted condition. The back stop rail 62 is formed and is configured to extend along a rearward portion of the bottom panel 20 between the first and second end panels 22, 24. The back stop rail 62 is connected with the bottom panel 20 and the first and second end panels 22, 24 to rigidify the case 26, and the back stop rail 62 is positioned to project upwardly from the bottom panel 20 to retain objects on the bottom panel 20. At least one accessory is provided and is configured to equip the interior portion of the case 26 and may be detachably connected with the back stop rail 62.

The first off-module support bracket 440 is formed having a rear portion 444 thereof with slots 446, 448 selectively receiving therein the second hooks 44 of the first and second hanger brackets 35, 36 in a vertical off-module panel-hung condition, a forward bottom portion 450 thereof abuttingly supporting thereon the bottom panel 20 of the case 26, and a forward top portion 454 thereof connected with the top panel 18 of the case 26 in a manner which permits the case 26 to shift laterally relative to the first and second hanger brackets 35, 36. The second off-module support bracket 472 is formed and includes a top bracket 470 having a rear portion 474 with horizontal hooks 476 shaped for reception in horizontal ones of the slotted hangers 16 on an associated one of the office furniture units 12, a top portion 478 with an upwardly extending flange 480 selectively engaging the top panel 18 of the case 26, a bottom bracket 490 having a rear portion 492 with horizontal hooks 494A, 494B shaped for reception in horizontal ones of the slotted hangers 16 in the associated one of the office furniture units 12, and a forward portion 496 with vertical hooks 498 selectively received in the slots 446, 448 in the rear portion 32 of the first and second end panels 22, 24 to detachably support the case 26 in a panel-hung condition against the outer face of the associated one of the office furniture units 26.

The socket 74 is formed in the bottom panel 20 along the bottom edge thereof and a lock housing 76 is formed with spring flanges 524 that frictionally engage adjacent portions of the socket 74 to securely retain the lock housing 76 in the bottom panel 20. A generally open front portion 80 in the case 26 is formed and disposed opposite the generally open back portion 30. The door 64A, 64B, 64C, 64D is operably connected with the case 26 to selectively enclose the generally open front portion 80 of the case 26. The over-the-case door support mechanism 312 is formed and the first portion the mechanism 312 is connected with the case 26 and the second portion of the mechanism 312 is connected with the door 64A, 64B, 64C, 64D to permit shifting the door 64A, 64B, 64C, 64D between the closed position over the open front portion 80 of the case 26 and an open position outside of the case 26 over the top panel 18. The in-the-case door support mechanism 361 is formed and a first portion of the mechanism 361 is connected with the case 26 and a second portion of the mechanism 361 is connected to the door 64″ to permit shifting the door 64″ between the closed position over the open front of the case 26 and the open position inside of the case 26 portion under the top panel 18.

The anti-racking mechanism 380 is formed and a first portion of the mechanism 380 is connected with the door 64″ and a second portion of the mechanism 380 with the case 26 to alleviate binding of the door 64″ when the same is shifted between the open and closed positions. A quick connect bracket 392 is formed and connects the second portion of the anti-racking mechanism 380 with the case 26.

The door dampener 370 is formed with the housing 371 pivotally attached to a top portion of the door 64″ and a rod portion 372 pivotally attached to an interior portion of the case 26. A door 64″ open assist 398 is provided having a longitudinally resilient construction with one end operably connected with the door 64″ and the opposite end operably connected with the case 26 to assist shifting the door 64″ from the closed position to the open position. A rigid reinforcing strut 900 is provided and is positioned along a medial portion of the back panel 56, and an upper end of the strut 900 is detachably connected with the top panel 18 and a lower end of the strut 900 with the bottom panel 20 to stiffen the case 26.

It is to be understood that variations and modifications can be made to the aforementioned structure without departing from the concepts of the present invention, and further it is to be understood that such concepts are intended to be covered by the following claims unless these claims by their language expressly state otherwise.

The invention claimed is as follows:

1. A storage unit assembly for office furniture units of the type having an outer face with slotted hangers extending therealong, comprising:
a bottom panel operably positioned in a generally horizontal orientation, and shaped to abuttingly support objects thereon;
a top panel disposed above and generally parallel with said bottom panel, and shaped to cover at least a portion of said bottom panel;
first and second end panels disposed at opposite ends of said top and bottom panels and connected therewith to define a rigid, box-shaped case having a generally rigid bottom portion and a generally open back portion; said first and second end panels having rear portions with a plurality of vertically spaced apart slots disposed therein;
first and second hanger brackets each having a rear portion with first hooks shaped for reception in the slotted hangers of an associated one of the office furniture units, and a forward portion with second hooks selectively received in said slots in said rear portions of said first and second end panels to detachably support said case in a panel-hung condition against the outer face of the associated one of the office furniture units;
an up-mount bracket having a lower portion shaped for connection with an associated one of the office furniture units, and an upper portion connected with and supporting said bottom portion of said case to detachably mount said case in an up-mounted condition above a top portion of the associated one of the furniture units; and
a removable back panel shaped to enclose at least a portion of said open back portion of said case, and having side portions with outwardly protruding hooks selectively received in said slots in said rear portions of said first and second end panels to detachably connect said back panel with said case and enclose at least that portion of said open back portion of said case disposed above the top portion of the associated one of the office furniture units when said case is in said up-mounted condition.

2. A storage unit assembly as set forth in claim 1, including:
an anti-dislodgement clip mounted on said case adjacent to one of said first and second end panels, and engaging said second hooks on said first hanger bracket in said panel-hung condition, and said hooks on said back panel in said up-mounted condition.

3. A storage unit assembly as set forth in claim 1, including:
a back stop rail extending along a rearward portion of said bottom panel between said first and second end panels; said back stop rail is connected with said bottom panel and said first and second end panels to rigidify said case, and projects upwardly from said bottom panel to retain objects thereon.

4. A storage unit assembly as set forth in claim 1, including:
a pair of connector brackets mounted on inside surfaces of said first and second end panels, and engaging said opposite ends of said bottom panel to rigidly interconnect said first and second end panels.

5. A storage unit assembly as set forth in claim 1, including:
a pair of clips mounted on top surfaces of said first and second end panels, and engaging said opposite ends of the top panel to interconnect said first and second end panels.

6. A storage unit assembly as set forth in claim 1, wherein:
said panel-hung condition defines an on-module panel-hung condition and includes
a first off-module support bracket having a rear portion thereof with slots selectively receiving therein said second hooks of said first and second hanger brackets in a vertical off-module panel-hung condition, a forward bottom portion thereof abuttingly supporting thereon said back stop rail, and a forward top portion thereof connected with said top panel of said case in a manner which permits said case to shift laterally relative to said first and second hanger brackets.

7. A storage unit assembly as set forth in claim 6, wherein:
said panel-hung condition defines an off-module panel-hung condition and includes
a second off-module support bracket including a top bracket having a rear portion with horizontal hooks shaped for reception in horizontal ones of the slotted hangers on an associated one of the office furniture units, a top portion with an upwardly extending flange selectively engaging said first off-module support bracket, a bottom bracket having a rear portion with horizontal hooks shaped for reception in horizontal ones of the slotted hangers in the associated one of the office furniture units, and a forward portion with vertical hooks selectively received in said slots in said rear portion of said first off-module bracket to detachably support said case in a panel-hung condition against the outer face of the associated one of the office furniture units.

8. A storage unit assembly as set forth in claim 1, wherein:
said bottom panel includes a socket positioned along a bottom edge thereof; and including
a lock housing having spring flanges that frictionally engage adjacent portions of said socket to securely retain said lock housing in said bottom panel.

9. A storage unit assembly as set forth in claim 1, wherein:
said case includes a generally open front portion disposed opposite said generally open back portion; and including:
a door operably connected with said case, and shaped to selectively enclose said generally open front portion of said case.

10. A storage unit assembly as set forth in claim 9, including:
an over-the-case door support mechanism having a first portion thereof connected with said case and a second portion thereof connected with said door, and configured to permit shifting said door between a closed position over said open front portion of said case and an open position outside of said case over said top panel.

11. A storage unit assembly as set forth in claim 9, including:
an in-the-case door support mechanism having a first portion thereof connected with said case and a second portion thereof connected with said door, and configured to permit shifting said door between a closed position over said open front of said case and an open position inside of said case under said top panel.

12. A storage unit assembly as set forth in claim 9, wherein:
said door comprises one of a plurality of different door constructions, including:
at least one solid door construction;
at least one curved front door construction; and
at least one picture frame door construction.

13. A storage unit assembly as set forth in claim 1, including:
an anti-racking mechanism having a first portion thereof operably connected with said door and a second portion thereof operably connected with said case, and configured to alleviate binding of said door when the same is shifted between said open and closed positions; and
a quick connect bracket connecting said second portion of said anti-racking mechanism with said case.

14. A storage unit assembly as set forth in claim 1, including:
a door dampener having a cylinder portion thereof pivotally attached to a top portion of said door, and a piston portion thereof pivotally attached to an interior portion of said top panel.

15. A storage unit assembly as set forth in claim 1, including:
a door open assist having a longitudinally resilient construction with one end thereof operably connected with said door and the opposite end thereof operably connected with said case to assist shifting said door from said closed position to said open position.

16. A storage unit assembly as set forth in claim 1, including:
a rigid reinforcing strut disposed along a medial portion of said back panel, and having an upper end thereof detachably connected with said top panel and a lower end thereof detachably connected with said bottom panel to stiffen said case.

17. A storage unit assembly as set forth in claim 1, wherein:
said rear portions of said first and second end panels define generally flat rear edges through which said slots extend.

18. A storage unit assembly as set forth in claim 1, wherein:
said first and second end panels have a formed, one-piece construction with said rear edges formed integral therein.

19. A storage unit assembly as set forth in claim 1, wherein:
said back panel includes an upper lip that extends inwardly from an upper portion of said back panel, and further includes a lower flange that extends inwardly and substantially orthogonally from a lower portion of said back panel.

20. A storage unit assembly as set forth in claim 19, wherein:
said upper lip of said back panel engages said top panel and said lower flange extends below said case proximate a pair of connector brackets mounted on inside surfaces of said first and second end panels when said case is in said up-mounted condition.

21. A storage unit assembly as set forth in claim 1, wherein:
said first and second end panels include a front flange extending therealong, wherein said front flange includes a lower edge adapted to receive and retain a front portion of said bottom panel.

22. A storage unit assembly as set forth in claim 1, wherein:
said top panel includes side flanges that extend below said top panel and which include clip apertures adapted to engage a pair of clips mounted on top surfaces of said first and second end panels and further includes a detent stop aperture for engaging a detent stop on said top surfaces of said first and second end panels.

23. In an office furniture unit having an outer face with slotted hangers extending therealong, the improvement of a removable storage unit assembly, comprising:
a bottom panel operably positioned in a generally horizontal orientation along said office furniture unit;
a top panel disposed above and generally parallel with said bottom panel;
first and second panels disposed at opposite ends of said top and bottom panels and connected therewith to define a rigid, box-shaped case having a generally open back portion; said first and second end panels having rear portions with a plurality of vertically spaced apart slots disposed therein; and
first and second hanger brackets each having a rear portion with first hooks selectively received in said slotted hangers of said office furniture units, and a forward portion with second hooks selectively received in said slots in said rear portions of said first and second end panels to detachably support said case in a panel-hung condition against said outer face of said office furniture unit.

24. An office furniture unit as set forth in claim 23, including:
an anti-dislodgement clip mounted on said case adjacent to one of said first and second end panels, and engaging said second hooks on an adjacent one of said hanger brackets in said panel-hung condition.

25. A storage unit assembly as set forth in claim 23, wherein:
said panel-hung condition defines an on-module panel-hung condition and includes
a first off-module support bracket having a rear portion thereof with slots selectively receiving therein said second hooks of said first and second hanger brackets in a vertical off-module panel-hung condition, a forward bottom portion thereof abuttingly supporting thereon said back stop rail, and a forward top portion thereof connected with said top panel of said case in a manner which permits said case to shift laterally relative to said first and second hanger brackets.

26. A storage unit assembly as set forth in claim 25, wherein:
said panel-hung condition defines an off-module panel-hung condition and includes
a second off-module support bracket including a top bracket having a rear portion with horizontal hooks shaped for reception in horizontal ones of the slotted hangers on an associated one of the office furniture units, a top portion with an upwardly extending flange selectively engaging said first off-module support bracket, a bottom bracket having a rear portion with horizontal hooks shaped for reception in horizontal ones of the slotted hangers in the associated one of the office furniture units, and a forward portion with vertical hooks selectively received in said slots in said rear portion of said first off-module bracket to detachably support said case in a panel-hung condition against the outer face of the associated one of the office furniture units.

27. A method for making a storage unit assembly for office furniture units of the type having a like construction with slotted hangers extending along outer faces thereof, comprising:
forming a bottom panel shaped to abuttingly support objects thereon;
forming a top panel shaped to cover at least a portion of the bottom panel;
positioning the top panel in a generally parallel, spaced apart relationship with the bottom panel;
forming first and second end panels with rear portions having a plurality of vertically spaced slots therein;
positioning the first and second end panels at opposite ends of the top and bottom panels and interconnecting the same to define a rigid, box-shaped case having a generally rigid bottom portion and a generally open back portion;
forming first and second hanger brackets each having a rear portion with first hooks shaped for reception in the slotted hangers of a first selected one of the office furniture units, and a forward portion with second hooks shaped for reception in the slots in the rear portions of the first and second end panels;
inserting the first hooks on the first and second hanger brackets into the slotted hangers on the first selected furniture unit;
inserting the second hooks on the first and second hanger brackets into the slots in the rear portions of the first and second end panels to detachably support the case in a panel-hung condition against the outer face of the first selected office furniture unit;
forming an up-mount bracket with a lower portion shaped for connection with a second selected one of the office furniture units, and an upper portion shaped for connection with the bottom portion of said case;
mounting the lower portion of the up-mount bracket with the second selected furniture unit;
connecting the upper portion of the up-mount bracket with the bottom portion of the case to detachably mount the case in an up-mounted condition above a top portion of the second selected furniture unit;
forming a removable back panel shaped to enclose at least a portion of the open back portion of said case, and having side portions with outwardly protruding hooks shaped for reception in the slots in said rear portions of the first and second end panels; and
inserting the hooks on the back panel into the slots in the rear portions of the first and second end panels to detachably connect the back panel with the case and enclose at least that portion of the open back portion of the case disposed above the top portion of the second selected office furniture unit when the case is in the up-mounted condition.

28. A method as set forth in claim 27, including:
mounting an anti-dislodgement clip on the case adjacent to one of the first and second end panels; and
engaging the second hooks on said first hanger bracket in said panel-hung condition, and the hooks on the back panel in the up-mounted condition.

29. A method as set forth in claim 28, including:
forming a back stop rail which is configured to extend along a rearward portion of the bottom panel between the first and second end panels; and
connecting the back stop rail with the bottom panel and the first and second end panels to rigidify said case, and positioning the back stop rail to project upwardly from the bottom panel to retain objects thereon.

30. A method as set forth in claim 29, including:
forming at least one accessory configured to equip an interior portion of said case; and
detachably connecting the accessory with the back stop rail.

31. A method as set forth in claim 30, including:
forming a first off-module support bracket having a rear portion thereof with slots selectively receiving therein said second hooks of said first and second hanger brackets in a vertical off-module panel-hung condition, a forward bottom portion thereof abuttingly supporting thereon said bottom panel of said case, and a forward top portion thereof connected with said top panel of said case in a manner which permits said case to shift laterally relative to said first and second mounting brackets.

32. A method as set forth in claim 31, including:
forming a second off-module support bracket including a top bracket having a rear portion with horizontal hooks shaped for reception in horizontal ones of the slotted hangers on an associated one of the office furniture units, a top portion with an upwardly extending flange selectively engaging said top panel of said case, a bottom bracket having a rear portion with horizontal hooks shaped for reception in horizontal ones of the slotted hangers in the associated one of the office furniture units, and a forward portion with vertical hooks selectively received in said slots in said rear portion of said first and second end panels to detachably support said case in a panel-hung condition against the outer face of the associated one of the office furniture units.

33. A method as set forth in claim 32, including:
forming a socket in the bottom panel along a bottom edge thereof; and including
forming a lock housing with spring flanges that frictionally engage adjacent portions of the socket to securely retain the lock housing in the bottom panel.

34. A method as set forth in claim 33, including:
forming a generally open front portion in the case disposed opposite said generally open back portion; and including:
operably connecting a door with the case to selectively enclose the generally open front portion of the case.

35. A method as set forth in claim 34, including:
forming an over-the-case door support mechanism; and
connecting a first portion of the mechanism with the case and a second portion of the mechanism with the door to permit shifting the door between a closed position over the open front portion of the case and an open position outside of the case over the top panel.

36. A method as set forth in claim 35, including:
forming an in-the-case door support mechanism; and
connecting a first portion of the mechanism with the case and a second portion of the mechanism with the door to permit shifting the door between a closed position over the open front of the case and an open position inside of the case portion under the top panel.

37. A method as set forth in claim 36, wherein:
the door comprises one of a plurality of different door constructions, including:
at least one solid door construction;
at least one curved front door construction;
at least one picture frame door construction; and
selecting one of the door constructions for attachment to the case.

38. A method as set forth in claim 37, including:
forming an anti-racking mechanism;
connecting a first portion of the mechanism with the door and a second portion of the mechanism with said case to alleviate binding of the door when the same is shifted between the open and closed positions; and
forming a quick connect bracket connecting the second portion of the anti-racking mechanism with the case.

39. A method as set forth in claim 38, including:
forming a door dampener with a cylinder portion pivotally attached to a top portion of the door, and a piston portion pivotally attached to an interior portion of the top panel.

40. A method as set forth in claim 39, including:
forming a door open assist having a longitudinally resilient construction with one end operably connected with the door and the opposite end operably connected with the case to assist shifting the door from the closed position to the open position.

41. A method as set forth in claim 40, including:
forming a rigid reinforcing strut for positioning along a medial portion of the back panel; and
detachably connecting an upper end of the strut with the top panel and a lower end of the strut with the bottom panel to stiffen the case.
